(19) United States
(12) Patent Application Publication
(10) Pub. No.: US 2006/0220590 A1
(43) Pub. Date: Oct. 5, 2006

(54) Operational amplifier, and amplitude modulator and transmitter using the same

(75) Inventors: Mitsuru Tanabe, Osaka (JP); Taiji Akizuki, Miyagi (JP); Koichiro Tanaka, Hyogo (JP); Takuo Hino, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/392,852

(22) Filed: Mar. 30, 2006

(30) Foreign Application Priority Data
Apr. 4, 2005 (JP) 2005-107116

(51) Int. Cl. H05B 37/02

(52) U.S. Cl. 315/209 R

(57) ABSTRACT

The operational amplifier outputs a signal for switching a switch circuit from a drive circuit according to signal amplitude information inputted from a signal source to thereby switch a plurality of supply voltages of a power amplification circuit arranged in an output portion. As a result of this, needed minimum DC power required for linear amplification for the voltage amplitude to be outputted can be provided to the power amplification circuit, allowing the operational amplifier to achieve an improvement in efficiency.

### BACKGROUND OF THE INVENTION

1. Field of the Invention

The present invention relates to an operational amplifier for use in a communication system of using a multicarrier signal, for example an OFDM (Orthogonal Frequency Division Multiplex) system or the like, and an amplitude modulator and a transmitter using the same.

2. Description of the Related Art

In general, in a modulation signal involving amplitude modulation, particularly in a modulation signal involving multi level modulation such as a quadrature amplitude modulation (hereinafter, referred also to as QAM), an amplification operation for linearly amplifying the signal is required for an RF power amplifier for transmitting electric power to an antenna. Hence, as an amplifier operating class, class A or class AB has been used for a high-frequency power amplifier.

Along with broadbandization of a communication, however, a communication system such as an Orthogonal Frequency Division Multiplex (hereinafter, referred also to as OFDM) system using a multicarrier signal has started to be used. However, if a conventional RF power amplifier with the amplifier operating class of class A or class AB is used in such a communication system, to achieve high efficiency in the communication system may not be anticipated. The reason is that, in the OFDM system described above, a large amount of electric power is instantaneously generated completely at random due to superposition of subcarriers. Namely, a ratio between an average power and an instantaneous peak power, i.e., a Peak to Average Power Ratio (hereinafter, referred also to as PAPR) is large. For this reason, a large amount of DC power needs to be consistently maintained so as to also linearly amplify the instantaneous peak power. In the class A operation, electric power efficiency thereof will be only 50% at the maximum, and particularly in the OFDM system, electric power efficiency thereof will result in about 10% because of high PAPR.

Meanwhile, if it is a case where a saturated type amplifier can be used, a period while a drain current and a drain voltage are simultaneously generated is reduced as short as possible, so that power consumption thereof can be suppressed low. The saturated type amplifier includes a class F amplifier in which a higher harmonic is controlled so that a drain voltage waveform may be a rectangular wave, or a class E amplifier or a class D amplifier in which a load condition is optimized so that a drain voltage waveform and a drain current waveform may not be overlapped.

For example, assuming that a DC current of 200 mA and a DC voltage of 3V (: Vdd) are supplied, the DC power will be 600 mW. In the saturated type amplifier composed of transistors, when the transistor is in OFF-state, the current may not flow, but only the voltage Vdd is applied, so that the DC power consumption will be zero. Meanwhile, when the transistor is in ON-state, the current of 200 mA will flow, but the transistor is completely conducted, so that it is assumed that a drain-source voltage VDS may be about 0.3 V at the maximum, which is a saturation voltage. In this case, it means that the amount of the DC power of 0.3×0.2=0.06, i.e., 60 mW is consumed in the transistor. The power efficiency reaches as high as (600−60)/600=90%. Since the power efficiency of the class A amplifier reaches 50% at the maximum, this effect is significant.

Hence, the saturated type amplifier will make it possible to achieve high power efficiency. However, since the saturated type amplifier operates as a nonlinear amplifier, modulation accuracy thereof is remarkably deteriorated, so that it may not be used for amplifying a signal in which an amplitude level of a modulated wave changes like a QAM signal.

In order to solve such a problem, a conventional EER (Envelope Elimination and Restoration) technique that is known as the Kahn's technique has been suggested (for example, refer to patent document 1).

FIG. 16 is a block diagram schematically showing the EER technique. In a transmitter shown in FIG. 16, a signal which is generated by a modulation signal generating means 50, for example a QAM signal, is separated into a phase component and an amplitude component by amplitude/phase separating means 51. The phase component is inputted into a quadrature modulator 52 as a quadrature signal to be thereby frequency-converted, and is outputted to a saturated type amplifier 53. Meanwhile, the amplitude component is amplified to a desired amplitude level by an operational amplifier 55 to be subsequently inputted into a DC converter 54. The DC converter 54 outputs a current required by the saturated type amplifier 53 to the saturated type amplifier 53 along with the amplitude component. In the saturated type amplifier 53, the phase component inputted as an RF, and the amplitude component inputted from a power supply via the DC converter 54 are multiplied with each other to restore a QAM modulated wave.

Employing such a configuration allows highly efficient amplifier such as the saturated type amplifier to be used even though it is a non-linear amplifier, thus an improvement in efficiency can be achieved.

Patent document 1: U.S. Pat. No. 6,256,482B1 (sheet 3 of the drawings, FIG. 6)

When the modulated signal is separated into the amplitude component and the phase component, a bandwidth thereof is generally spread about 5 times. For example, in the case of an OFDM signal in conformity with an IEEE802.11a standard which is a standard for radio LAN, since a signal bandwidth of a baseband is approximately 8 MHz, it will be spread to a bandwidth of 40 MHz. However, a bandwidth of the DC converter 54, for example a switching regulator, for modulating the amplitude component is at most 1 MHz, so that a conventional configuration may not be realize the EER technique for such a signal.

In order to spread the bandwidth, an increase in speed of a switching element of the DC converter (switching regulator) 54 is required. Whereas, since an improvement in speed of the switching element will lead to a decrease in withstand voltage thereof, it is considered that a further improvement in speed beyond this may not be made.

In addition, when a series regulator is used as the DC converter 54, a product between the amount of DC conversion (difference between a supply voltage and an amplitude component voltage) and a drain current of the RF power amplifier will be given as power consumption thereof. In the OFDM system, since an average voltage of the amplitude component is equal to one half of the supply voltage or less, an improvement in efficiency may not be anticipated in this case, either.

Further, in order to amplify the amplitude component without distortion also in the operational amplifier 55, the supply voltage equal to a peak amplitude component or more needs to be maintained, so that the OFDM system that has a large difference between the peak voltage and the average voltage will lead a reduction in power efficiency.

### SUMMARY OF THE INVENTION

Therefore, it is an object of the present invention to provide an operational amplifier which can greatly improve efficiency when a signal electric power with a large difference between a peak power and an average power is inputted, and an amplitude modulator and a transmitter using the same.

In order to solve the aforementioned problems, an operational amplifier according to a first aspect of the present invention includes a differential amplifier for receiving a signal electric power, a power amplification circuit for amplifying an output voltage of the differential amplifier, and power control means for step-wisely switching at least either of a DC power supply voltage applied to the power amplification circuit and a direct current supplied to the power amplification circuit according to a voltage amplitude value of the signal electric power.

According to this configuration, since at least either of the DC power supply voltage applied to the power amplification circuit and the direct current supplied to the power amplification circuit according to the voltage amplitude value of the signal electric power is step-wisely switched, a voltage drop between a collector and an emitter of the transistor composing the power amplification circuit can be suppressed low in a range where distortion may not occur in the output voltage therefrom, so that electric power determined by a product between a current flowing through between the collector and the emitter of the transistor composing the power amplification circuit, and the aforementioned voltage drop can be suppressed low. As a result, particularly when a signal electric power with a large difference between a peak power and an average power is inputted, efficiency of the operational amplifier can be greatly improved.

According to a second aspect of the present invention, in the operational amplifier of the first aspect of the present invention, there is provide the operational amplifier further including a phase compensation circuit which is located between an output terminal of the differential amplifier and an output terminal of the power amplification circuit and adjusts the amount of phase advance of the output voltage of the power amplification circuit, with respect to the signal electric power.

According to this configuration, a positive feedback to the differential amplifier can be prevented, thus allowing a stable negative feedback operation to be achieved.

According to a third aspect of the present invention, in the operational amplifier of the first aspect of the present invention, there is provided the operational amplifier further including a plurality of power supply circuits which have step-wisely different voltage values and supply DC power to the power amplification circuit, a switch circuit which is located between the plurality of power supply circuits and the power amplification circuit and selects any one of the plurality of power supply circuits, and a control circuit which receives voltage amplitude information of the signal electric power and controls the switch circuit based on the voltage amplitude information of the signal electric power.

According to this configuration, there is employed a configuration that the plurality of power supply circuits having step-wisely different voltage values are provided, any one of the plurality of the power supply circuits is selected according to the voltage amplitude information of the signal electric power, and the power amplification circuit amplifies the electric power outputted from the differential amplifier using the output voltage of the selected power supply circuit as the supply voltage. For that reason, the voltage drop between the collector and the emitter of the transistor composing the power amplification circuit can be suppressed low in a range where distortion may not occur in the output voltage therefrom, so that a power loss determined by a product between the current flowing through between the collector and the emitter of the transistor composing the power amplification circuit, and the aforementioned voltage drop can be suppressed low. As a result, particularly when a signal electric power with a large difference between a peak power and an average power is inputted, efficiency of the operational amplifier can be greatly improved.

According to a fourth aspect of the present invention, in the operational amplifier of the first aspect of the present invention, there is provided the operational amplifier, wherein a plurality of the power amplification circuits are provided, and output terminals of the plurality of power amplification circuits are commonly connected together. The power control means then has a plurality of power supply circuits which form pairs with the plurality of power amplification circuits, and have step-wisely different voltage values to supply DC power to the plurality of power amplification circuits, a switch circuit which is located between an output terminal of the differential amplifier and an input terminal of the plurality of power amplification circuits, and selects a connection between the differential amplifier and the plurality of power amplification circuits, and a control circuit which receives voltage amplitude information of the signal electric power and controls the switch circuit based on the voltage amplitude information of the signal electric power.

According to this configuration, there is employed a configuration that the plurality of power supply circuits having step-wisely different voltage values are provided, any one of the plurality of the power supply circuits is selected according to the voltage amplitude information of the signal electric power, and the power amplification circuit amplifies the electric power outputted from the differential amplifier using the output voltage of the selected power supply circuit as the supply voltage. For that reason, the voltage drop between the collector and the emitter of the transistor composing the power amplification circuit can be suppressed low in a range where distortion may not occur in the output voltage therefrom, so that a power loss determined by a product between the current flowing through between the collector and the emitter of the transistor composing the power amplification circuit, and the aforementioned voltage drop can be suppressed low. As a result, particularly when a signal electric power with a large difference between a peak power and an average power is inputted, efficiency of the operational amplifier can be greatly improved.

Moreover, unlike the third aspect of the present invention, the switch circuit is not disposed between the power supply circuit and the power amplification circuit, so that power consumption determined by a product between a voltage drop between a collector and an emitter of the transistor composing the switch circuit, and a current flowing through the switch circuit can be reduced. Accordingly, as compared with the configuration of the third aspect of the present invention, it is possible to provide the operational amplifier capable of further reducing the power loss.

According to a fifth aspect of the present invention, in the operational amplifier of the first aspect of the present invention, there is provided the operational amplifier, wherein the power control means has a plurality of current source circuits which have step-wisely different current values and supply direct currents to the power amplification circuit, a switch circuit for selecting any one of the plurality of current source circuits, and a control circuit which receives voltage amplitude information of the signal electric power and controls the switch circuit based on the voltage amplitude information of the signal electric power.

According to this configuration, there is employed a configuration that the plurality of current source circuits having step-wisely different current values are provided, any one of the plurality of current source circuits is selected according to the voltage amplitude information of the signal electric power, and the power amplification circuit amplifies the electric power outputted from the differential amplifier by the bias current of the selected current source circuit. For that reason, the current flowing through between the collector and the emitter of the transistor composing the power amplification circuit can be suppressed low in a range where distortion may not occur in the output voltage therefrom, so that a power loss determined by a product between the voltage drop between the collector and the emitter of the transistor composing the power amplification circuit, and the aforementioned current can be suppressed low. As a result, particularly when a signal electric power with a large difference between a peak power and an average power is inputted, efficiency of the operational amplifier can be greatly improved.

Moreover, since a plurality of power supply circuits are not required, a passive element involved in the power supply circuit can be reduced, thus making it possible to achieve a reduction in cost based on a reduction in mounting area and the number of parts.

According to a sixth aspect of the present invention, in the operational amplifier of the first aspect of the present invention, there is provided the operational amplifier, wherein the power control means has a plurality of power supply circuits which have step-wisely different voltage values and supply DC power to the power amplification circuit, a first switch circuit which is located between the plurality of power supply circuits and the power amplification circuit and selects any one of the plurality of power supply circuits, a plurality of current source circuits which have step-wisely different current values and supply direct currents to the power amplification circuit, a second switch circuit for selecting any one of the plurality of current source circuits, and a control circuit which receives voltage amplitude information of the signal electric power and controls the first and second switch circuits based on the voltage amplitude information of the signal electric power.

According to this configuration, there is employed a configuration that both of the plurality of power supply circuits having step-wisely different voltage values, and the plurality of current source circuits having step-wisely different current values are provided, any one of the power supply circuits and any one of the current source circuits are selected according to the voltage amplitude information of the signal electric power, and the power amplification circuit amplifies the electric power outputted from the differential amplifier using an output voltage of a selected power supply circuit as the supply voltage, and a bias current of a selected current source circuit. For that reason, the voltage drop between the collector and the emitter of the transistor composing the power amplification circuit can be suppressed low in a range where distortion may not occur in the output voltage therefrom, and the current flowing through between the collector and the emitter of the transistor composing the power amplification circuit can also be suppressed low in a range where distortion may not occur in the output voltage therefrom, so that a power loss determined by a product between the current flowing through between the collector and the emitter of the transistor composing the power amplification circuit, and the voltage drop thereof can be suppressed lower than that of the third through fifth aspects of the present invention. As a result, particularly when a signal electric power with a large difference between a peak power and an average power is inputted, efficiency of the operational amplifier can be greatly improved.

According to a seventh aspect of the present invention, in the operational amplifier of the first aspect of the present invention, there is provided the operational amplifier, wherein a plurality of the power amplification circuits are provided, and output terminals of the plurality of power amplification circuits are commonly connected together. The power control means then has a plurality of power supply circuits which form pairs with the plurality of power amplification circuits, and have step-wisely different voltage values to supply DC power to the plurality of power amplification circuits, a first switch circuit which is located between the output terminal of the differential amplifier and the input terminal of the plurality of power amplification circuits, and selects a connection between the differential amplifier and the plurality of power amplification circuits, a plurality of current source circuits which have step-wisely different current values and supply direct currents to the power amplification circuit, a second switch circuit for selecting any one of the plurality of current source circuits, and a control circuit which receives voltage amplitude information of the signal electric power and controls the first and second switch circuits based on the voltage amplitude information of the signal electric power.

According to this configuration, there is employed a configuration that both of the plurality of power supply circuits having step-wisely different voltage values and the plurality of current source circuits having step-wisely different current values are provided, any one of the power supply circuits and any one of the current source circuits are selected according to the voltage amplitude information of the signal electric power, and the power amplification circuit amplifies the electric power outputted from the differential amplifier using an output voltage of a selected power supply circuit as the supply voltage, and a bias current of a selected current source circuit. For that reason, the voltage drop between the collector and the emitter of the transistor composing the power amplification circuit can be suppressed low in a range where distortion may not occur in the output voltage therefrom, and the current flowing through between the collector and the emitter of the transistor composing the power amplification circuit can also be suppressed low in a range where distortion may not occur in the output voltage therefrom, so that a power loss determined by a product between the current flowing through between the collector and the emitter of the transistor composing the power amplification circuit, and the voltage drop thereof can be suppressed lower than that of the third through fifth aspects of the present invention. As a result, particularly when a signal electric power with a large difference between a peak power and an average power is inputted, efficiency of the operational amplifier can be greatly improved.

Moreover, unlike the sixth aspect of the present invention, the switch circuit is not disposed between the power supply circuit and the power amplification circuit, so that power consumption determined by a product between the voltage drop between the collector and the emitter of the transistor composing the switch circuit, and the current flowing through the switch circuit can be reduced. Accordingly, as compared with the configuration of the sixth aspect of the present invention, it is possible to provide the operational amplifier capable of further reducing the power loss.

According to an eighth aspect of the present invention, in the operational amplifier of any one of the third to fifth aspects of the present invention, there is provided the operational amplifier, wherein the control circuit is composed of a plurality of comparator circuits. Assuming herein that a propagation delay of the plurality of comparator circuits is t1, a propagation delay from the comparator circuit to the switch circuit is t2, a propagation delay of the switch circuit is t3, a time when a voltage obtained by multiplying a reference voltage of the plurality of comparator circuits by a gain of the power amplification circuit is equal to the voltage amplitude value of the signal electric power is tx, and a voltage amplitude value of the signal electric power at time tx−(t1+t2+t3) is Vy, the reference voltage of the plurality of comparator circuits is selected so that the output voltage of the plurality of power supply circuits may be larger than Vy.

According to this configuration, an inversion phenomenon of the voltages between the collector and the emitter of the transistor composing the power amplification circuit caused by the propagation delay from the control circuit to the switch circuit can be prevented, thereby making it possible to prevent distortion of the output voltage amplitude caused by the aforementioned inversion phenomenon.

An amplitude modulator according to a ninth aspect of the present invention includes the operational amplifier according to the first aspect of the present invention, a DC-DC converter for DC converting an output of the operational amplifier, a feedback circuit for feeding back an output of the DC-DC converter to a feedback terminal of the operational amplifier.

According to this configuration, since the highly efficient operational amplifier according to the first aspect of the present invention can be used, current consumption of the amplitude modulator can be suppressed low.

According to a tenth aspect of the present invention, in the amplitude modulator of the ninth aspect of the present invention, there is provided the amplitude modulator further including a plurality of power supply circuits for converter for supplying DC power to the DC-DC converter, a switch circuit for converter which is located between the plurality of power supply circuits for converter and the DC-DC converter, and selects any one of the plurality of power supply circuits for converter, and a control circuit for converter which receives voltage amplitude information of a signal electric power and controls the switch circuit for converter based on the voltage amplitude information of the signal electric power.

According to this configuration, since the highly efficient operational amplifier according to the first aspect of the present invention can be used, current consumption of the operational amplifier composing the amplitude modulator can be suppressed low. Additionally, there is employed a configuration that the plurality of power supply circuits for converter having step-wisely different voltage values are provided, any one of the power supply circuits for converter is selected according to the voltage amplitude information of the signal electric power, and the DC-DC converter DC converts the electric power outputted from the operational amplifier using the output voltage of the selected power supply circuit for converter as the supply voltage. For that reason, a voltage drop between a collector and an emitter of the transistor composing the DC-DC converter can be suppressed low in a range where distortion may not occur in the output voltage therefrom, so that a power loss determined by a product between a current flowing through between the collector and the emitter of the transistor composing the DC-DC converter, and the aforementioned voltage drop can be suppressed low. Accordingly, as compared with the amplitude modulator of the ninth aspect of the present invention, current consumption can be further suppressed low.

According to an eleventh aspect of the present invention, in the amplitude modulator of the ninth aspect of the present invention, there is provided the amplitude modulator, wherein a plurality of DC-DC converters are provided, and output terminals of the plurality of DC-DC converters are commonly connecter with each other together. The amplitude modulator further has a plurality of power supply circuits for converter which form pairs with the plurality of DC-DC converters and supply DC power to the plurality of DC-DC converters, a switch circuit for converter which is located between the operational amplifier and the plurality of DC-DC converters, and selects a connection between the operational amplifier and the plurality of DC-DC converters, and a control circuit for converter which receives voltage amplitude information of the signal electric power and controls the switch circuit for converter based on the voltage amplitude information of the signal electric power.

According to this configuration, since the highly efficient operational amplifier according to the first aspect of the present invention can be used, current consumption of the operational amplifier composing the amplitude modulator can be suppressed low. Additionally, there is employed a configuration that the plurality of power supply circuits having step-wisely different voltage values are provided, any one of the plurality of the power supply circuits is selected according to the voltage amplitude information of the signal electric power, and the DC-DC converter DC converts the electric power outputted from the operational amplifier using the output voltage of the selected power supply circuit as the supply voltage. For that reason, the voltage drop between the collector and the emitter of the transistor composing the DC-DC converter can be suppressed low in a range where distortion may not occur in the output voltage therefrom, so that a power loss determined by a product between the current flowing through between the collector and the emitter of the transistor composing the DC-DC converter, and the aforementioned voltage drop can be suppressed low.

Moreover, unlike the tenth aspect of the present invention, the switch circuit is not disposed between the power supply circuit and the DC-DC converter, so that power consumption determined by a product between the voltage drop between the collector and the emitter of the transistor composing the switch circuit, and the current flowing through the switch circuit can be reduced. Accordingly, as compared with the configuration of the tenth aspect of the present invention, it is possible to provide the amplitude modulator capable of further reducing the power loss.

According to a twelfth aspect of the present invention, in the amplitude modulator of the tenth or eleventh aspect of the present invention, there is provided the amplitude modulator, wherein the control circuit is composed a plurality of comparator circuits. Assuming herein that a propagation delay of the plurality of comparator circuits is t1, a propagation delay from the comparator circuit to the switch circuit for converter is t2, a propagation delay of the switch circuit for converter is t3, a time when a voltage obtained by multiplying a reference voltage of the plurality of comparator circuits by a gain of the power amplification circuit is equal to the voltage amplitude value of the signal electric power is tx, and a voltage amplitude value of the signal electric power at time tx−(t1+t2+t3) is Vy, the reference voltage of the plurality of comparator circuits is selected so that the output voltage of the plurality of power supply circuits for converter may be larger than Vy.

According to this configuration, an inversion phenomenon of the voltages between the collector and the emitter of the transistor composing the power amplification circuit and the DC-DC converter caused by the propagation delay from the control circuit to the switch circuit can be prevented, thereby making it possible to prevent distortion of the output voltage amplitude caused by the aforementioned inversion phenomenon.

A transmitter according to a thirteenth aspect of the present invention includes a modulation signal generator, a phase/amplitude detector which is composed of an amplitude detector for detecting an amplitude component of a modulation signal generated by the modulation signal generator, and a phase detector for detecting a phase component of the modulation signal generated by the modulation signal generator, the amplitude modulator according to the ninth aspect of the present invention for receiving the amplitude component detected by the phase/amplitude detector, a frequency converter for converting the phase component detected by the phase/amplitude detector into a carrier frequency, and an RF power amplifier for receiving an output of the amplitude modulator and an output of the frequency converter to thereby generate a modulated wave.

According to this configuration, since the highly efficient amplitude modulator according to the ninth aspect of the present invention is used, and the RF power amplifier is further operated in a saturated operation capable of highly efficient operation, current consumption of the transmitter can be suppressed low.

A transmitter according to a fourteenth aspect of the present invention includes a modulation signal generator an amplitude detector for detecting an amplitude component of a modulation signal which is generated by the modulation signal generator, the amplitude modulator according to the ninth aspect of the present invention for receiving the amplitude component detected by the amplitude detector, a frequency converter for converting the modulation signal generated by the modulation signal generator, into a carrier frequency, and an RF power amplifier for receiving an output of the amplitude modulator and an output of the frequency converter to thereby generate a modulated wave.

According to this configuration, since the highly efficient amplitude modulator according to the ninth aspect of the present invention is used, and the RF power amplifier is further operated in the saturated operation capable of highly efficient operation, current consumption of the transmitter can be suppressed low. Moreover, since a pseudo phase component provided by saturating an IQ quadrature modulated wave with the RF power amplifier is used instead of the phase component, deterioration of modulation accuracy resulted from subjecting the phase component to a bandwidth restriction in the signal circuit throughout the RF power amplifier is not caused.

As described above in detail, according to the present invention, while the highly efficient operational amplifier, and the amplitude modulator and the transmitter can be provided, a broadband and highly efficient operation can be achieved in the EER method which allows the RF power amplifier to operate as the saturated type amplifier.

### BRIEF DESCRIPTION OF THE DRAWINGS

FIG. 1A is a circuit diagram schematically showing a configuration of an operational amplifier of a first embodiment of the present invention;

FIG. 1B is a circuit diagram concretely showing the configuration of the operational amplifier of the first embodiment of the present invention;

FIG. 2A is a circuit diagram showing a configuration of one example of a drive circuit in the operational amplifier of the first embodiment of the present invention;

FIG. 2B is a wave form diagram showing the operation of one example of the drive circuit in the operational amplifier of the first embodiment of the present invention;

FIG. 3A is a circuit diagram showing a configuration of another example of the drive circuit in the operational amplifier of the first embodiment of the present invention;

FIG. 3B is a wave form diagram showing the operation of another example of the drive circuit in the operational amplifier of the first embodiment of the present invention;

FIG. 4 is a wave form diagram explaining a determining method of a reference voltage in the cases of not considering and considering delay in the first embodiment of the present invention;

FIG. 5A is a circuit diagram schematically showing a configuration of an operational amplifier of a second embodiment of the present invention;

FIG. 5B is a circuit diagram concretely showing the configuration of the operational amplifier of the second embodiment of the present invention;

FIG. 6A is a circuit diagram schematically showing a configuration of an operational amplifier of a third embodiment of the present invention;

FIG. 6B is a circuit diagram concretely showing the configuration of the operational amplifier of the third embodiment of the present invention;

FIG. 7A is a characteristic graph for explaining the operation of the first and second embodiments of the present invention;

FIG. 7B is a characteristic graph for explaining the operation of the third embodiment of the present invention;

FIG. 8A is a circuit diagram schematically showing a configuration of an operational amplifier of a fourth embodiment of the present invention;

FIG. 8B is a circuit diagram concretely showing the configuration of the operational amplifier of the fourth embodiment of the present invention;

FIG. 9 is a characteristic graph for explaining the operation of the fourth embodiment of the present invention;

FIG. 10A is a circuit diagram schematically showing a configuration of an operational amplifier of a fifth embodiment of the present invention;

FIG. 10B is a circuit diagram concretely showing the configuration of the operational amplifier of the fifth embodiment of the present invention;

FIG. 11 is a circuit diagram showing a configuration of an amplitude modulator of a sixth embodiment of the present invention;

FIG. 12 is a circuit diagram showing a configuration of an amplitude modulator of a seventh embodiment of the present invention;

FIG. 13 is a circuit diagram showing a configuration of an amplitude modulator of an eighth embodiment of the present invention;

FIG. 14 is a circuit diagram showing a configuration of a transmitter of a ninth embodiment of the present invention;

FIG. 15 is a circuit diagram showing a configuration of a transmitter of a tenth embodiment of the present invention; and

FIG. 16 is a block diagram schematically showing an EER technique.

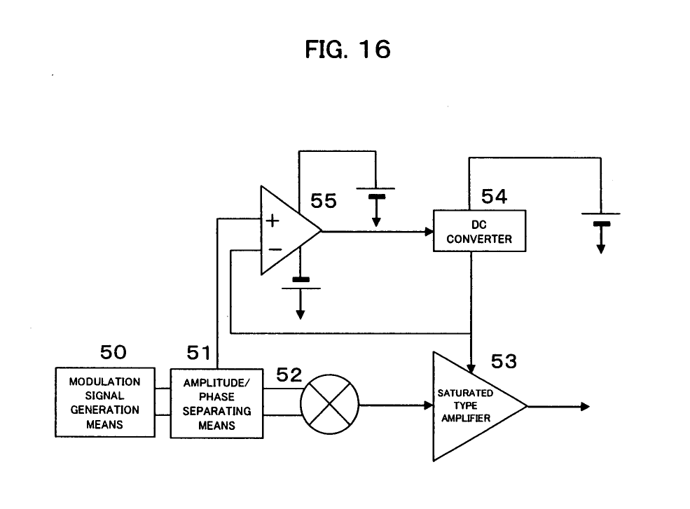

### DETAILED DESCRIPTION OF THE PREFERRED EMBODIMENTS

Hereafter, referring to the drawings, embodiments of the present invention will be explained.

### First Embodiment

Hereafter, a first embodiment of the present invention will be described with reference to the drawings.

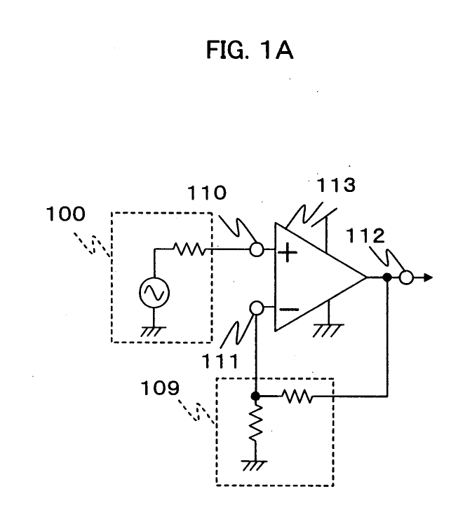

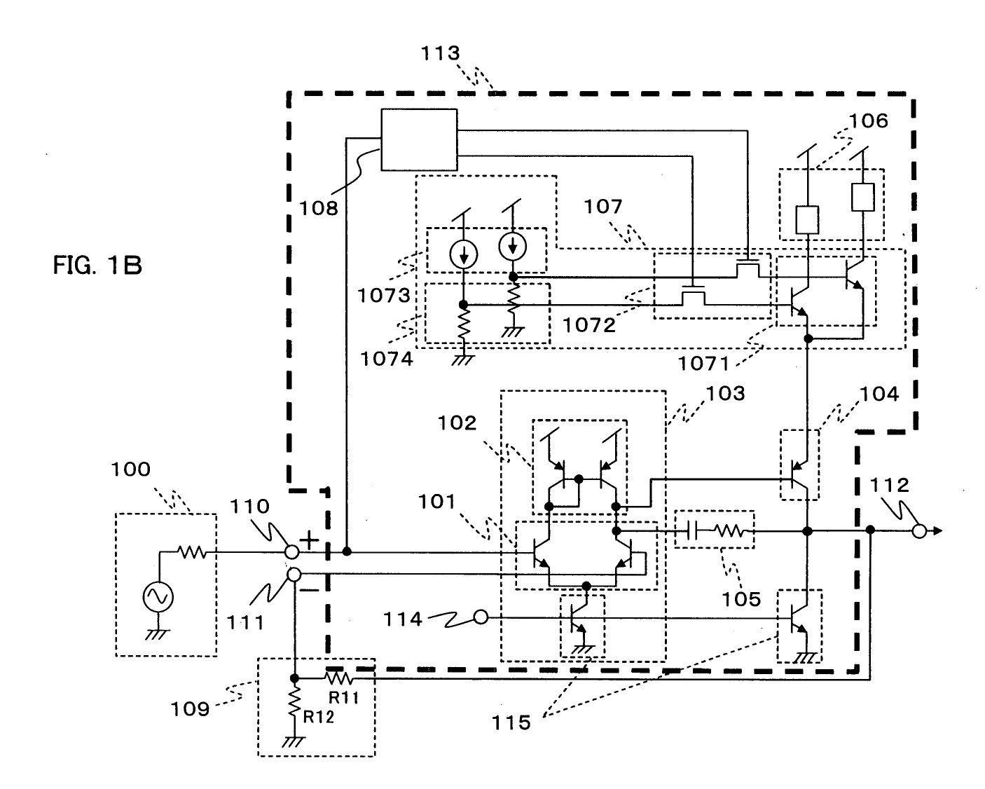

FIGS. 1A and 1B show circuit diagrams of an operational amplifier according to the first embodiment of the present invention.

An operational amplifier 113 herein is composed of a differential amplifier 103, a power amplification circuit 104, a phase compensation circuit 105, a plurality of power supply circuits 106, a switch circuit 107, and a drive circuit 108, as shown in FIGS. 1A and 1B. Here, power control means is composed of the plurality of power supply circuits 106, the switch circuit 107, and the drive circuit 108.

The differential amplifier 103 is composed of a differential pair 101 which is composed of, for example, NPN transistors, and a current mirror circuit 102 which is composed of, for example, PNP transistors. The power amplification circuit 104 is composed of, for example, a PNP transistor. The phase compensation circuit 105 is composed of a series connection of, for example, a capacitance and a resistance. The plurality of power supply circuits 106 are composed of, for example, a DC-DC converter, respectively.

The switch circuit 107 is composed of, for example, a plurality of NPN transistors 1071, a plurality of NMOS transistors 1072 which form pairs with the plurality of NPN transistors 1071, and control and turn on/off base currents of the plurality of NPN transistors 1071, and series connection circuits composed of a plurality of resistances 1074 and a plurality of current sources 1073, which form pairs with the plurality of NPN transistors 1071 and supply DC biases to the plurality of NPN transistors 1071, respectively. The drive circuit 108 is composed a plurality of comparators. Reference numeral 112 represents an output terminal.

In the present embodiment, an example in which the operational amplifier 113 is used as a positive feedback amplifier will be described. For this reason, a feedback circuit 109 is configured so as to feed back an output signal to a negative feedback terminal 111. The feedback circuit 109 is composed resistances R11 and R12.

Additionally, in the present embodiment, bias currents provided to the differential amplifier 103 and the power amplification circuit 104 are determined by a voltage applied to a terminal 114, and an area ratio between two NPN transistors 115 used as current sources.

Next, the operation will be described. A voltage signal generated by a signal generator 100 is first inputted into a positive feedback terminal 110 of the operational amplifier 113, and then inputted into the differential pair 101. In the differential pair 101, a voltage amplitude Vin1 of the signal inputted from the signal generator 100 is converted into a current I1 expressed by following formula (1) based on a transconductance gm1 that depends on an operating point of the transistor composing the differential pair 101.
I1=gm1Vin1 (1)

The above current I1 produces the same amount of current by the current mirror circuit 102, at the side of the transistor connected with the negative feedback terminal 111 in the differential pair 101. As a result, a current of 2×I1 is outputted from the output of the differential amplifier 103.

The output current is voltage converted by an output conductance of the current mirror circuit 102, and a parallel impedance of an output conductance of the differential pair 101 and an input impedance of the power amplification circuit 104, and an input voltage amplitude Vin2 of the power amplification circuit 104 is produced. The voltage amplitude Vin2 inputted into the power amplification circuit 104 is current converted by the transconductance gm2 of the power amplification circuit 104, and an output current I2 expressed by following formula (2) is produced.
I2=gm2Vin2 (2)

The above current I2 is voltage converted by a parallel impedance of an output conductance of the power amplification circuit 104, an output conductance of the current source of the power amplification circuit 104, and an impedance of the feedback circuit 109.

This output voltage is divided by the feedback circuit 109, so that an voltage amplitude given by multiplying the output amplitude by R12/(R11+R12) is fed back to the negative feedback terminal 111 of the operational amplifier 113.

Here, when there is a difference in magnitude between the voltage amplitude fed back to the negative feedback terminal 111, and the voltage amplitude inputted into the positive feedback terminal 110, the differential amplifier 103 produces a large output voltage to thereby increase the gain of the output voltage. Consequently, the amplitudes of the input voltage and the feedback voltage finally become the same magnitude, resulting in a converged state.

However, when a phase of the voltage to be fed back to the negative feedback terminal 111 becomes a phase of the voltage amplitude that is inverted by 180 degrees to that of the input voltage amplitude, a positive feedback is performed in the differential amplifier 103, and both of the two input terminals of the differential pair 101 operate in phase. As a result, the gain will keep increasing and the amplitude will be saturated at the output amplitude limit of the differential amplifier 103, resulting in a so-called oscillation state.

In order to suppress such an oscillation, the phase compensation circuit 105 adjusts the phase of the output voltage so that a phase difference between an output voltage amplitude of the power amplification circuit 104 and an input voltage amplitude inputted into the differential pair 101 may not exceed 180 degrees, and in general, may be equal to 135 degrees or less in a range in which the operational amplifier 113 has the gain.

In addition to the aforementioned fundamental operation of the operational amplifier, the operational amplifier 113 in this embodiment has following functions. As can be seen from the drawings, the plurality of power supply circuits 106 are connected to an emitter terminal of the power amplification circuit 104, and the foregoing plurality of power supply circuits 106 are switched by the switch circuit 107 that is driven by the drive circuit 108, so that the operational amplifier operates so as to decrease a voltage between the emitter and the collector of the transistor composing the power amplification circuit 104, thus allowing the operational amplifier 113 to efficiently operate.

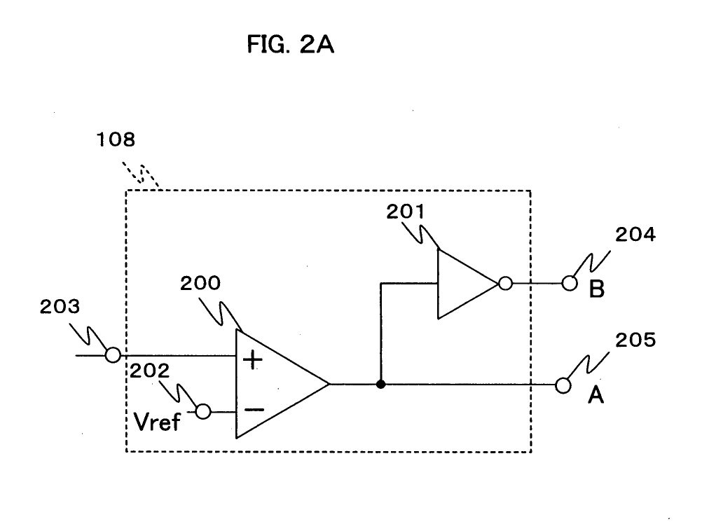

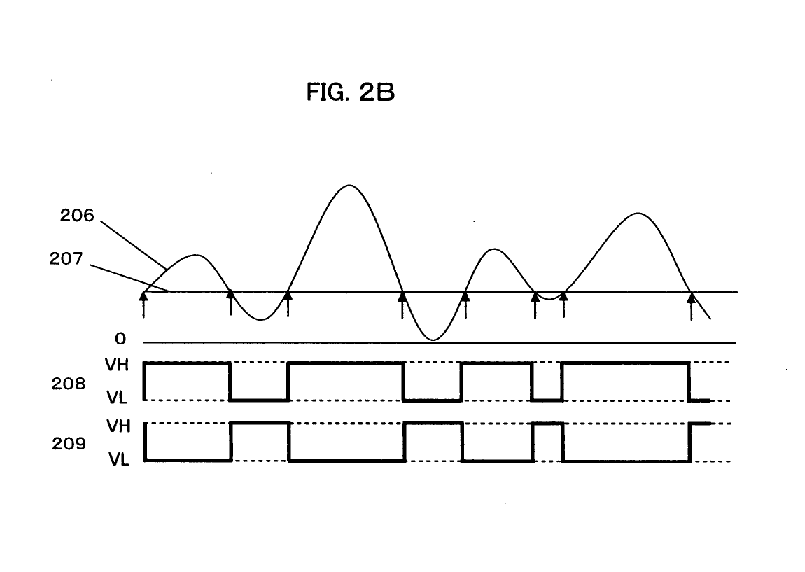

Herein, a configuration and a drive method of the drive circuit 108 will be described. FIG. 2A is a circuit diagram showing the drive circuit 108 in detail, whereas FIG. 2B is a wave form diagram showing an output logic signal with respect to a signal voltage amplitude. In FIG. 2A, reference numeral 200 represents a comparator; reference numeral 201, an inverter; reference numeral 202, a reference voltage terminal; reference numeral 203, an input terminal; reference numeral 205, a terminal A; and reference numeral 204, a terminal B. In FIG. 2B, reference numeral 206 represents the voltage amplitude outputted from the power amplification circuit 104; reference numeral 207, a voltage given by multiplying the reference voltage by the gain of the operational amplifier; reference numeral 208, a logic amplitude of a terminal A; and reference numeral 209, a logic amplitude of a terminal B.

The drive circuit 108 is composed of a comparator circuit which is composed of the comparator 200 and the inverter 201. A reference voltage Vref given by dividing, for example a supply voltage by resistances is provided to the reference voltage terminal 202. A voltage amplitude inputted into the input terminal 203 is compared with the reference voltage Vref, and when, in the present embodiment, the voltage is larger than the reference voltage Vref, an output of the comparator 200 results in a High level, whereas it is smaller than that the reference voltage, the output results in a Low level. The same logic signal as that of the comparator 200 is outputted to the terminal A 205, and a reverse logic signal is outputted to the terminal B 204 by the inverter 201.

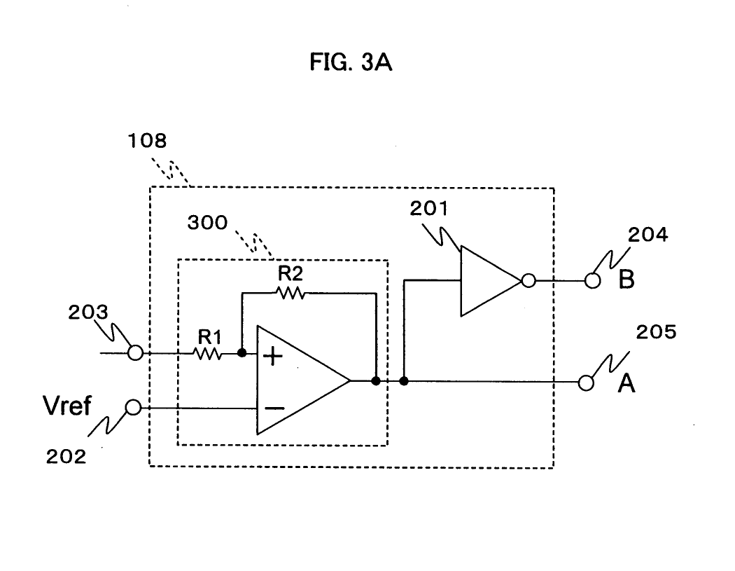

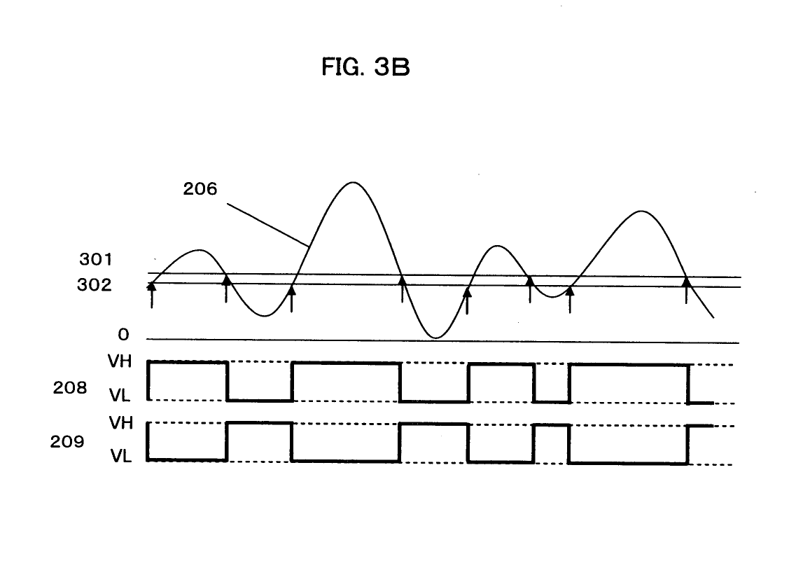

FIG. 3A is a circuit diagram of the drive circuit 108 when a hysteresis comparator 300 is employed instead of the comparator 200, while FIG. 3B is a wave form diagram showing the output logic signal with respect to the signal voltage amplitude. In FIG. 3A, symbols R1 and R2 represent resistances. In FIG. 3B, reference numeral 301 represents a threshold voltage VthH expressed by formula (3), and reference numeral 302 represents a threshold voltage VthL expressed by formula (4).
VthH=(R1+R2)Vref/R2−R1Voutmax/R2 (3)
VthL=(R1+R2)Vref/R2−R1Voutmin/R2 (4)

Employing the hysteresis comparator can increase resistance against the noise of the input signal.

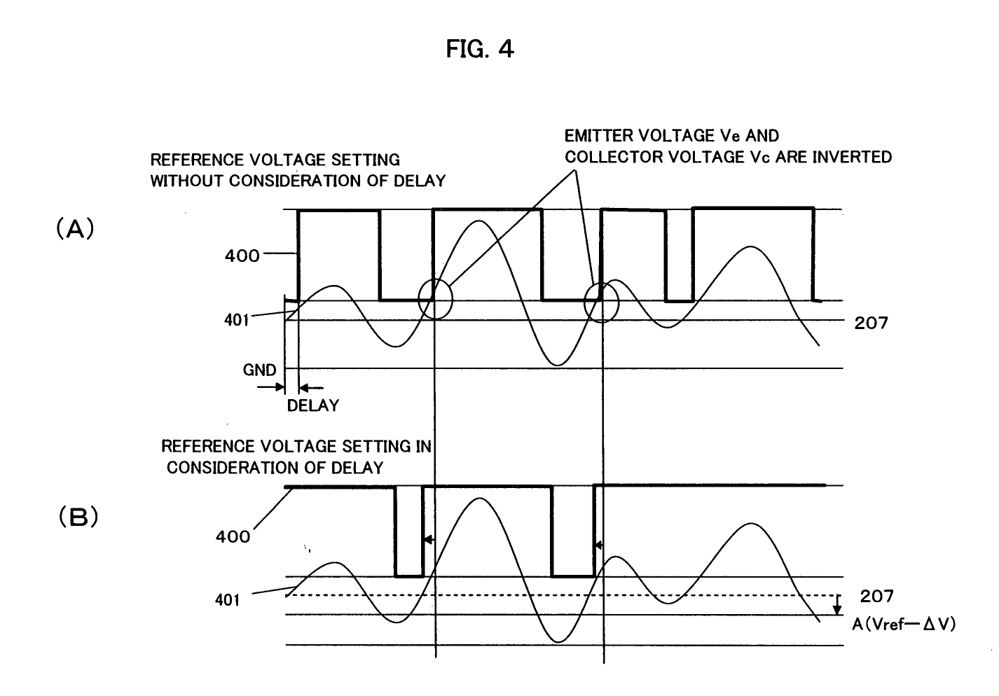

Next, how to determine the reference voltage will be described. FIGS. 4(A) and (B) show a relation between a supply voltage 400 that is finally outputted to the emitter terminal of the power amplification circuit 104 by a control signal outputted from the drive circuit 108, and an output voltage amplitude 401 that is outputted to a collector terminal of the power amplification circuit 104. FIG. 4(A) shows a case where a signal delay is not taken into consideration, whereas FIG. 4(B) shows a case where the signal delay is taken into consideration.

As is clear from FIGS. 1A and 1B, since propagation delays between a signal circuit for selecting the plurality of power supply circuits 106 and a signal circuit until the input voltage amplitude is outputted to the power amplification circuit 104 are different, as shown in FIG. 4(A), the delay generally occurs between two signals (the supply voltage 400 outputted to the emitter terminal of the power amplification circuit 104, and the output voltage amplitude 401 outputted to the collector terminal of the power amplification circuit 104). In the present embodiment, it is supposed that the delay of the signal circuit for selecting the power supply circuit 106 is larger.

Since such delay produces the inversion phenomenon between an emitter voltage Ve and a collector voltage Vc of the power amplification circuit 104 as shown in FIG. 4(A), the current flows in the reverse direction or is blocked at the timing of generating the inversion, resulting in a fatal signal transmission error to be produced.

For that reason, in selecting the reference voltage, the control signal needs to be outputted earlier by the time length of the delay as shown in FIG. 4(B).

In the present embodiment, a technique of advancing the timing of the control signal by means of setting the reference voltage to be lower than that when the delay is not present will be described.

A reference voltage when the delay is not taken into consideration will be selected as follows. Assuming that a voltage gain (closed loop gain) of the operational amplifier 113 is A, an output voltage of the plurality of power supply circuits 106 in selecting the low voltage is VL, a drop voltage Vd of the NPN transistor 1071 of the switch circuit 107 during the operation is Vd, a collector-emitter saturation voltage of the transistor of the power amplification circuit 104 is Vsat, the reference voltage Vref will be expressed by formula (5) as follows.
Vref=(VL−Vd−Vsat)/A (5)

Next, a reference voltage when the delay is taken into consideration will be determined as follows. A propagation delay of the drive circuit 108, the propagation delay from the drive circuit 108 to the switch circuit 107, a propagation delay of the switch circuit 107 are assumed to be t1, t2, and t3, respectively. Supposing that a slew rate S1 of the input signal near the reference voltage Vref has been known beforehand, a voltage difference ΔV due to the delay will be expressed by formula (6).
ΔV=S1(t1+t2+t3) (6)

Hence, the reference voltage in consideration of the delay will be provided by Vref−ΔV. After the delay is taken into consideration, the inversion phenomenon between the collector voltage and the emitter voltage of the power amplification circuit 104 may not be produced as shown in FIG. 4(B).

Next, efficiency that may be achieved by the present embodiment will be described. Since power consumption of the differential amplifier 103 can be generally ignored as compared with power consumption of the power amplification circuit 104, it is supposed that current consumption of the operational amplifier 113 is determined by the power amplification circuit 104. Since the operational amplifier 113 is premised on linear amplification, it is considered that an operating point thereof is in the middle point of a voltage and current amplitude range.

It is assumed herein that a maximum amplitude of a signal to be considered is 3 Vpp and a mean amplitude thereof is 0.3 Vpp, and a probability in which amplitude equal to 0.3 Vpp or more will appear is 10%.

Since the operating point of the power amplification circuit 104 is determined by the NPN transistor 115 forming the constant current source, the same current is flowing as a bias current during not only the peak magnitude but also the mean amplitude. Assuming that a value of this current is 0 mA, power consumption of the conventional operational amplifier having one power supply will be as follows.
10 mA*3 V=30 mw

Meanwhile, in the operational amplifier 113 according to the present embodiment, a power supply with the lowest voltage among the plurality of power supply circuits 106 is selected during the average voltage. When a voltage of the lowest power supply is set to 1.5V+0.3 V=1.8V, the voltage during the mean amplitude can also be linearly amplified. Accordingly, the power consumption according to the present embodiment will be
1.8 V*10 mA*0.9+3 V*10 mA*0.1=19.2 mW,
the operational amplifier 113 of the present embodiment can achieve an improvement in efficiency by 1.6 times as compared with the conventional operational amplifier.

According to the aforementioned configuration of the present embodiment, the supply voltage of the power amplification circuit 104 of the operational amplifier 113 is selected according to the input voltage amplitude of the operational amplifier 113, so that an improvement in efficiency of the operational amplifier can be achieved.

Moreover, the inversion between the collector voltage and the emitter voltage of the power amplification circuit 104 can be prevented by designing the reference voltage of the drive circuit 108 in consideration of the delay, thus providing the output signal voltage without distortion.

It should be noted herein that while the drive circuit 108 has been included in the operational amplifier 113 according to the present embodiment, it might be out of the operational amplifier 113, and in, for example, a digital signal processing LSI for generating the input signal voltage. In this case, the signal processing LSI sets the reference voltage in the same way of thinking as the setting technique of the reference voltage of the drive circuit 108, and outputs a signal for driving the switch circuit 107 resulted from the comparison with the reference voltage.

### Second Embodiment

Hereafter, a second embodiment of the present invention will be described with reference to the drawings.

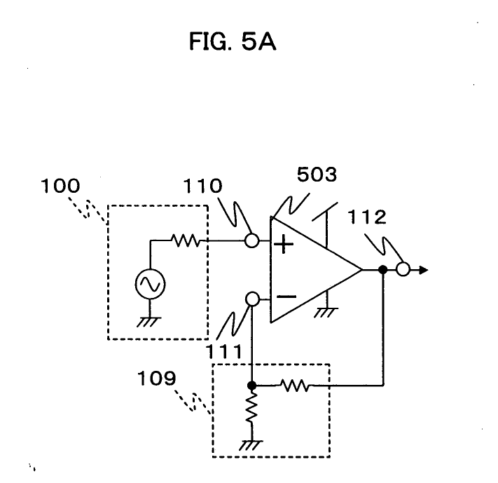

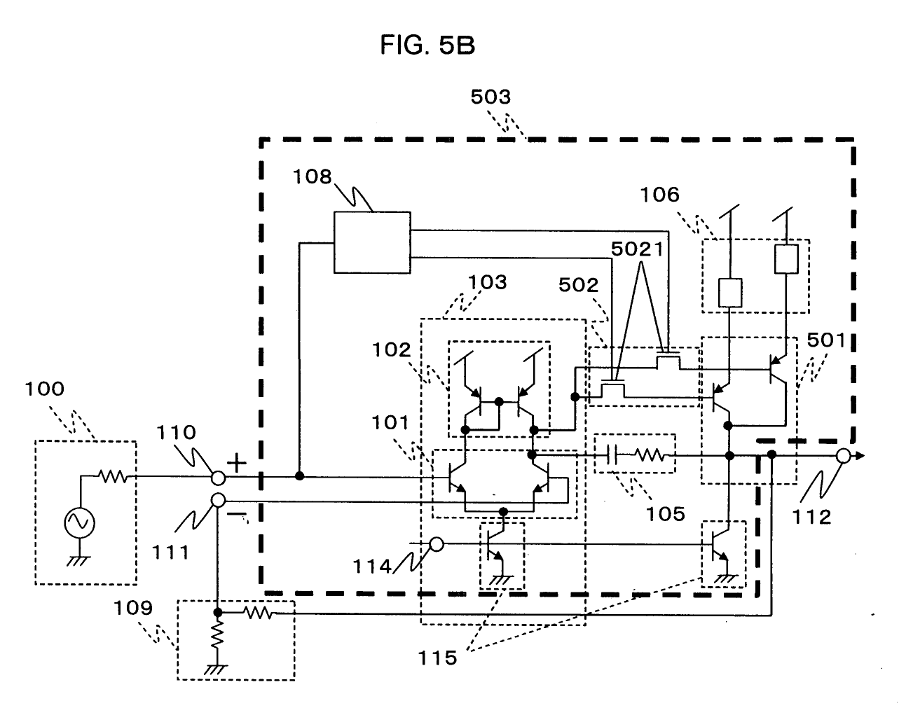

FIGS. 5A and 5B show circuit diagrams of an operational amplifier 503 according to the second embodiment of the present invention.

The present embodiment is different from the first embodiment in that a switch circuit 502 composed a plurality of NMOS transistors 5021 is disposed between the differential amplifier 103 and a plurality of power amplification circuits 501. The same reference numeral is given to an element having the same function as that of the first embodiment for the sake of simplification, and description thereof will be omitted. Here, power control means is composed the plurality of power supply circuits 106, the switch circuit 502, and the drive circuit 108.

The operation of the switch circuit 502 will be described. The switch circuit 502 turns on and off a current that the differential amplifier 103 outputs. Moreover, the plurality of power amplification circuits 501, which form pairs with the switch circuits 502, are turned on and off by an output voltage of the differential amplifier that are turned on and off by the switch circuit 502. The plurality of power amplification circuits 501 are connected with the plurality of power supply circuits 106, respectively, and electric powers that the plurality of power amplification circuits 501 can output are different, respectively. For example, a power amplification circuit connected with a power supply circuit which supplies a lower voltage is selected in a voltage amplitude near the average voltage, while a power amplification circuit connected with a power supply circuit which supplied a higher voltage is selected in a voltage amplitude near the maximum voltage.

Next, a setting technique of the reference voltage of the drive circuit 108 will be described. When each of the power amplification circuits is selected, the reference voltage of the drive circuit 108 is selected so that the collector voltage, and the output voltage of the power supply circuit may be larger than the emitter-collector saturation voltage of the power amplification circuit. In other words, assuming that a voltage gain (closed loop gain) of the operational amplifier 503 is A, an output voltage of the plurality of power supply circuits 106 in selecting the low voltage is VL, and the collector-emitter saturation voltage of the transistor of the plurality of power amplification circuits 501 is Vsat, the reference voltage Vref will be expressed by formula (7) as follows.
Vref=(VL−Vsat)/A (7)

Further, in consideration of delay in a manner similar to that of the first embodiment, a propagation delay of the drive circuit 108, a propagation delay from the drive circuit 108 to the switch circuit 502, a propagation delay of the switch circuit 502 are assumed to be t1, t2, and t3, respectively. Supposing that a slew rate S1 of the signal near the reference voltage Vref has been known beforehand, a voltage difference ΔV due to the delay will be expressed by formula (8).
ΔV=S1(t1+t2+t3) (8)

Hence, the reference voltage in consideration of the delay will be provided by Vref−ΔV.

According to a configuration of the present embodiment, the switch circuit 107 between the plurality of power supply circuits 106 and the power amplification circuit 104 as shown in FIG. 1B is not present, thus, eliminating undesirable influence resulted from the voltage drop of the NPN transistor 1071. As a result of this, it is possible to reduce power consumption that is determined by a product between a current flowing through the power amplification circuit 501 and the voltage drop, so that a further improvement in efficiency will be anticipated as compared with the first embodiment.

Moreover, according to the first embodiment, in the case of a voltage signal that frequently changes, switching frequency is decreased as shown in FIGS. 4(A) and 4(B), so that it is disadvantageous for an improvement in efficiency, whereas according to the present embodiment, since the switch circuit 502 can be simplified, the propagation delay of the switch circuit is reduced, so that the reference voltage can be set higher. For that reason, the switching frequency of the voltage can be increased as compared with that of the first embodiment, thereby making it possible to achieve an improvement in efficiency.

### Third Embodiment

Hereafter, a third embodiment of the present invention will be described with reference to the drawings.

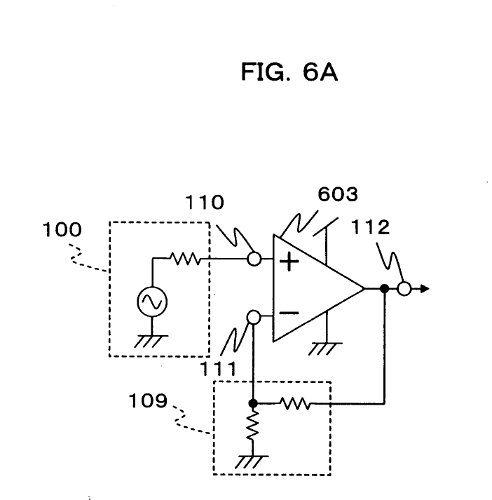

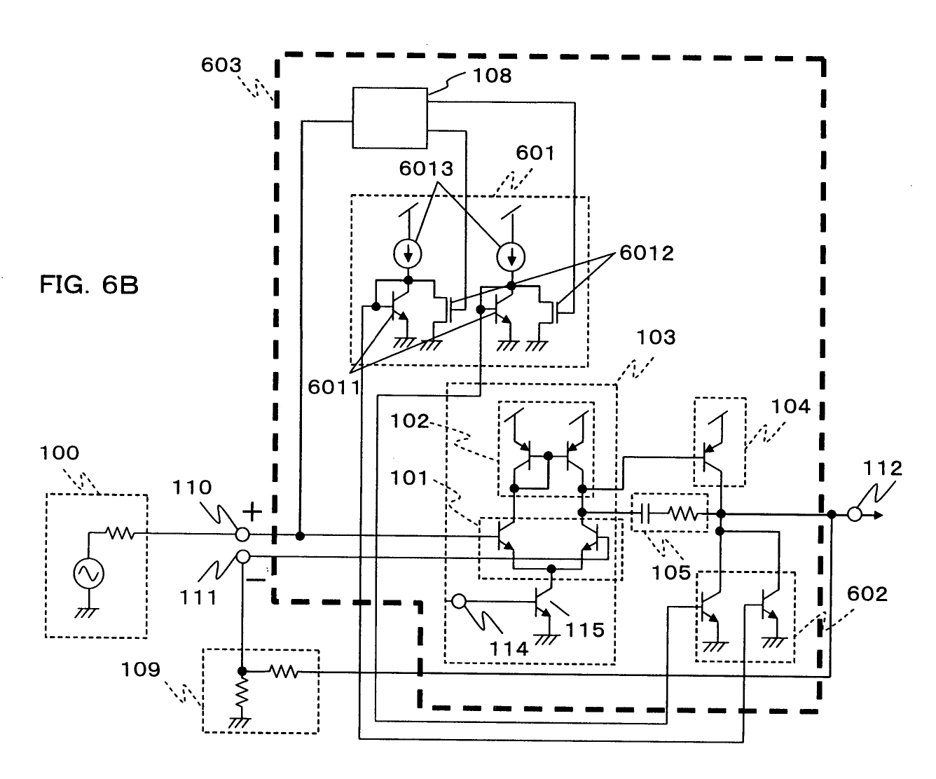

FIGS. 6A and 6B show circuit diagrams of an operational amplifier 603 according to the third embodiment of the present invention. According to the first and second embodiments, the DC power provided to the power amplification circuits 104 and 501 has been changed by the plurality of power supply circuits 106, whereas the present embodiment is different from the first and second embodiments in that the emitter terminal of the power amplification circuit 104 is connected to a fixed power supply, and a bias current supplied to the power amplification circuit 104 is switched using a plurality of current source circuits 602. The same reference numeral is given to an element having the same function as that of the first and second embodiments for the sake of simplification, and description thereof will be omitted. Here, power control means is composed the plurality of current source circuits 602, a switch circuit 601, and the drive circuit 108.

The operation of the switch circuit 601 will be described. The switch circuit 601 is composed of a plurality of current sources 6013, the plurality of current source circuits 602 for supplying a bias current for the power amplification circuit 104, a diode connected NPN transistor 6011 which forms a current mirror, and a NMOS transistor 6012 which bypasses the foregoing diode connected NPN transistor 6011. The NMOS transistor 6012 is then turned on and off by a control signal of the drive circuit 108, so that a base voltage of the current source circuit 602 is switched between an operating voltage and a GND potential, thereby the current source circuit 602 is switched.

A setting technique of the reference voltage in the present embodiment will be described. According to the first and second embodiments, since the constant current is supplied to the power amplification circuits 104 and 501 as the bias current, an operating point 702 may not change, whereas, according to the present embodiment, the current source circuits 602 are switched, so that the operating point changes from 711 to 712, and from 712 to 711.

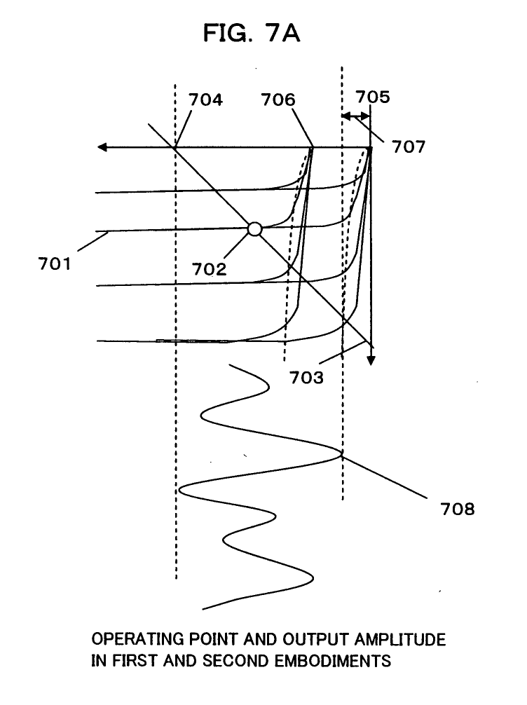

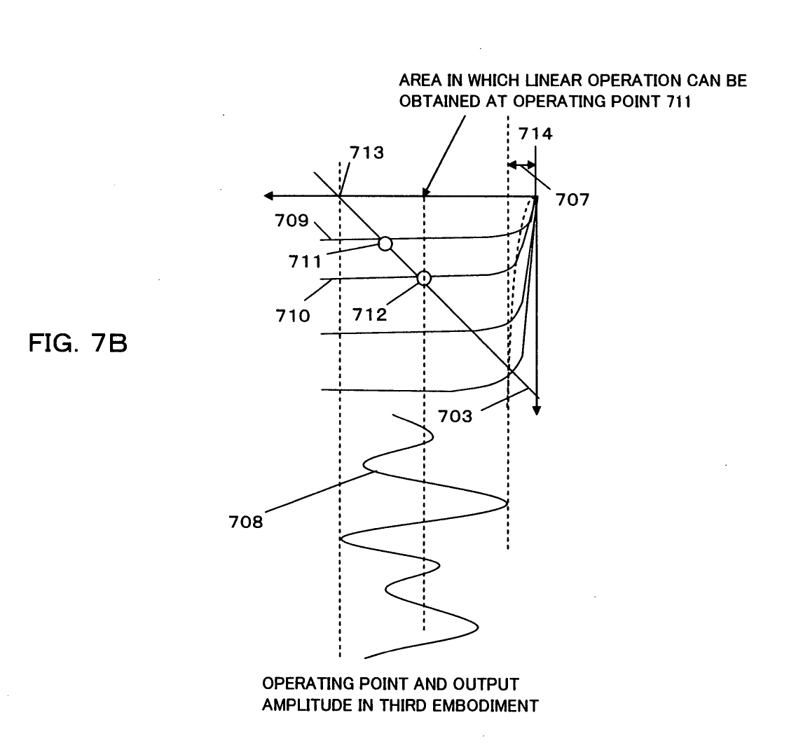

In the first and second embodiments, and the present third embodiment, FIGS. 7A and 7B are characteristic graphs showing changes of current vs. voltage characteristics of the power amplification circuit provided by switching the switch circuit and its DC operating point, and a load line and a behavior of the voltage amplitude to be outputted. In FIGS. 7A and 7B, reference numeral 701 represents a current source current in the first and second embodiments; reference numeral 702, the operating point of the first and second embodiments; reference numeral 703, the load line of the first, second, and third embodiments; reference numeral 704, the collector voltage of the NPN transistor 115 used as a current source; reference numeral 705, the higher voltage of the plurality of power supply circuits 106; reference numeral 706, the lower voltage of the plurality of power supply circuits 106; reference numeral 707, a collector voltage (saturation voltage) of the PNP transistor composing the power amplification circuit; reference numeral 708, the output voltage amplitude; reference numeral 709, a lower current of the plurality of current source circuits 602; reference numeral 710, a high current of the plurality of current source circuits 602; reference numeral 711, the operating point in outputting the lower current; reference numeral 712, the operating point in outputting the higher current; reference numeral 713, a collector voltage (saturation voltage) of the plurality of current source circuits 602; and reference numeral 714, an emitter fixed voltage of the PNP transistor in the third embodiment.

As shown in FIG. 7A, in the first and second embodiments, since the fixed bias current is provided to the power amplification circuits 104 and 501 by the NPN transistor 115 that serves as a current source, even when the power supply circuit 106 is selected by the switch circuit 107 and 502, the current source current 701 which is the bias current may not change.

By switching the power supply circuits 106, the current vs. voltage characteristics of the power amplification circuits 104 and 501 are shifted with respect to the load line 703. Consequently, when the voltage drop of the switch circuit 107 has not been taken into consideration, the reference voltage has been provided as (VL−Vsat)/A.

It has been described that, as described in the first embodiment, the power consumption in the output voltage range lower than the reference voltage has been able to be improved by performing such power supply switching, and the efficiency as the operational amplifier has been increased by 1.6 times in the signal provided as an example.

Meanwhile, in the present third embodiment, since the bias current is switched by the switch circuit 601 while keeping the power supply of the power amplification circuit 104 constant, the current vs. voltage characteristic of the power amplification circuit 104 are not shifted, but the operating point of the power amplification circuit 104 shifts from 711 to 712, and from 711 to 712 as shown in FIG. 7B. As a result, the reference voltage which may not take the delay into consideration is determined in a voltage range in which the linear amplification can be made in the operating point 711 of the lower current 709 of the current source circuit 602.

Assuming that the current 709 of a current source 1 is Iop1, the current 710 of a current source 2 is Iop2, the saturation voltage 713 of the current source is Vsat1, the saturation voltage 707 of the power amplification circuit is Vsat2, and the fixed voltage 714 is Vdd, since a load impedance is constant even when an operating current is changed, the reference voltage Vref is given by formula (9) as follows.
(Vdd−Vsat1−Vsat2)/Iop1=(Vref−Vsat1)/Iop2
Vref=Iop2(Vdd−Vsat1−Vsat2)/Iop1+Vsat1 (9)
Note herein that since ΔV in the case of taking the delay into consideration is the same as that of the first and second embodiments, description thereof will be omitted.

According to a configuration of the present embodiment, since the plurality of power supply circuits are not employed, the circuit can be simplified as compared with the first and second embodiments, and a passive element involved in the power supply circuit also becomes unnecessary, advantageously allowing a reduction in mounting area and cost.

### Fourth Embodiment

Hereafter, a forth embodiment of the present invention will be described with reference to the drawings.

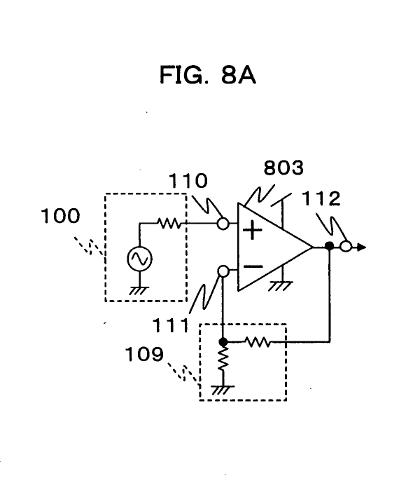

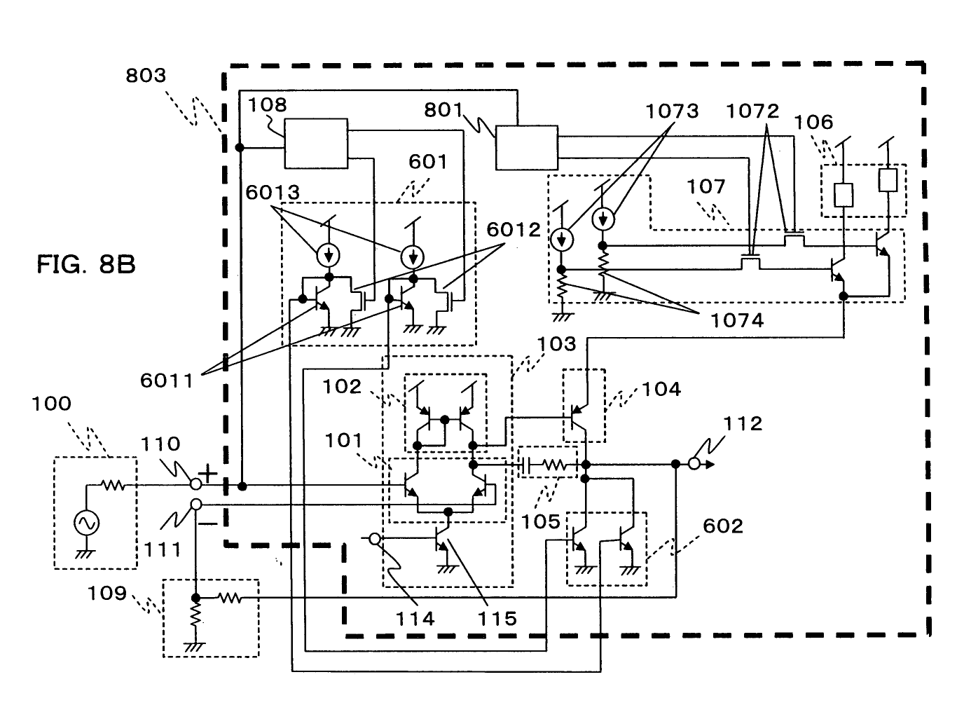

FIGS. 8A and 8B show circuit diagrams of an operational amplifier 803 according to the fourth embodiment of the present invention. The present embodiment will be provided by combining the first embodiment and the third embodiment. The same reference numeral is given to an element having the same function as that of the first and third embodiments for the sake of simplification, and description thereof will be omitted. Reference numeral 801 is a drive circuit having a similar configuration to that of the drive circuit 108. Here, power control means is composed of the plurality of power supply circuits 106, the plurality of current source circuits 602, the switch circuits 107 and 601, and the drive circuits 108 and 801.

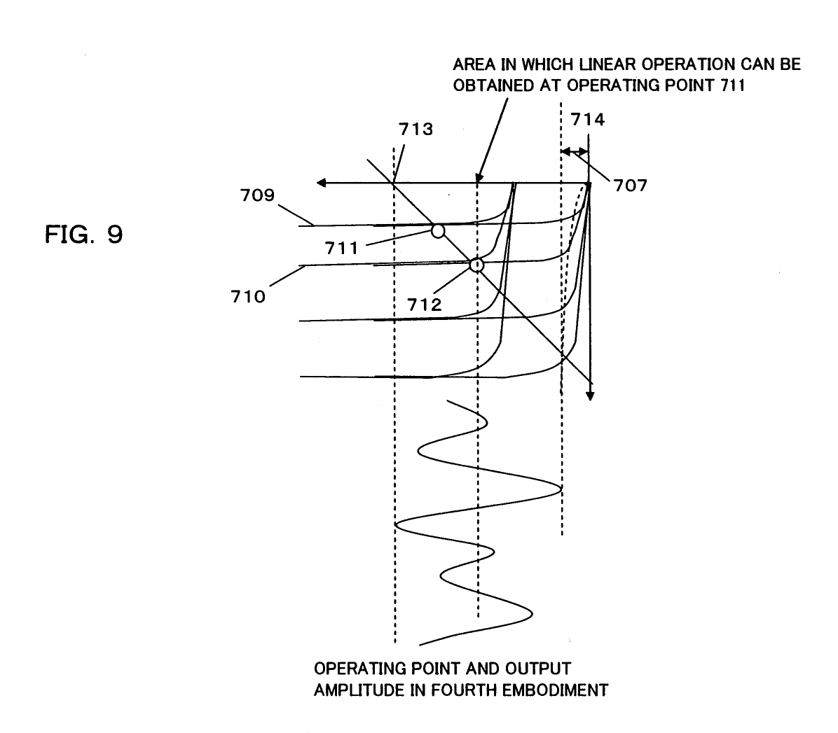

FIG. 9 is a characteristic graph for explaining the operation of the present embodiment.

According to the present embodiment, the shift of the current vs. voltage characteristics of the power amplification circuit 104 by switching the supply voltages described in the third embodiment, and a shift of an operating point by switching of current source circuits 602 will be simultaneously performed.

The supply voltage has been constant in the third embodiment, whereas, in the present embodiment, the supply voltage is set to the minimum voltage in which a linear operation at the low current 709 is can be made, thereby making it possible to achieve a further reduction in power consumption as compared with the third embodiment. Incidentally, since a setting technique of the reference voltage according to the present embodiment is the same as that of the third embodiment, description thereof will be omitted.

### Fifth Embodiment

Hereafter, a fifth embodiment of the present invention will be described with reference to the drawings.

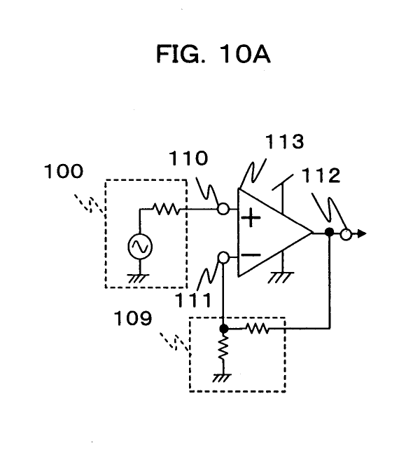

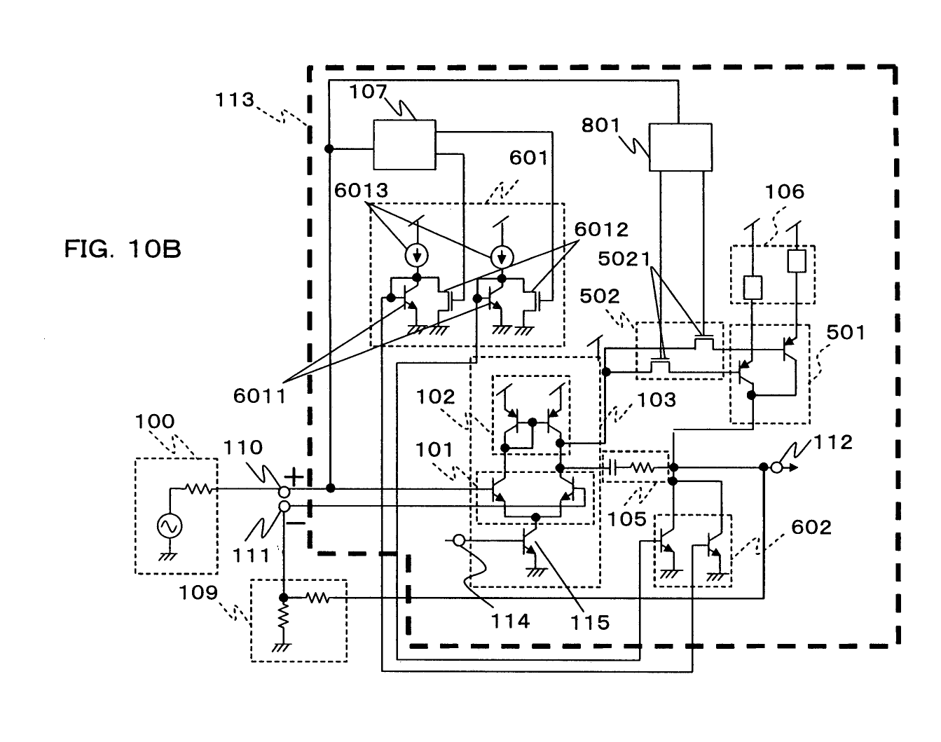

FIGS. 10A and 10B show circuit diagrams of an operational amplifier according to the fifth embodiment of the present invention.

The present embodiment will be provided by combining the second embodiment and the third embodiment. The same reference numeral is given to an element having the same function as that of the second and third embodiments for the sake of simplification, and description thereof will be omitted. Since the operation of the present embodiment is the same as that of the fourth embodiment, description thereof will be omitted. Here, power control means is composed of the plurality of power supply circuits 106, the plurality of current source circuits 602, the switch circuits 502 and 601, and the drive circuits 108 and 801.

According to a configuration of the present fifth embodiment, since the switch circuit 107 between the plurality of power supply circuits 106 and the power amplification circuit 104 as shown in FIG. 8B is not present, an undesirable influence resulted from the voltage drop of the NPN transistor 1071 is eliminated, so that it is possible to reduce power consumption that is determined by a product between a current flowing through the power amplification circuit 501 and the voltage drop of the NPN transistor 1071, and a further improvement in efficiency will be anticipated as compared with the fourth embodiment.

Additionally, according to the fourth embodiment, in the case of a voltage signal that frequently changes, switching frequency is decreased as shown in FIGS. 4(A) and 4(B), so that it is disadvantageous for an improvement inefficiency, whereas according to the present embodiment, since the switch circuit 502 can be simplified, the propagation delay of the switch circuit is reduced, so that the reference voltage can be set higher. For that reason, the switching frequency of the voltage can be increased as compared with that of the fourth embodiment, thereby making it possible to achieve an improvement in efficiency.

The supply voltage has been constant in the third embodiment, whereas, in the present embodiment, the supply voltage is set to the minimum voltage in which a linear operation at the low current 709 can be made, thereby making it possible to achieve a further reduction in power consumption as compared with the third embodiment.

Incidentally, since a setting technique of the reference voltage according to the present embodiment is the same as that of the third embodiment, description thereof will be omitted.

### Sixth Embodiment

Hereafter, a sixth embodiment of the present invention will be described with reference to the drawings.

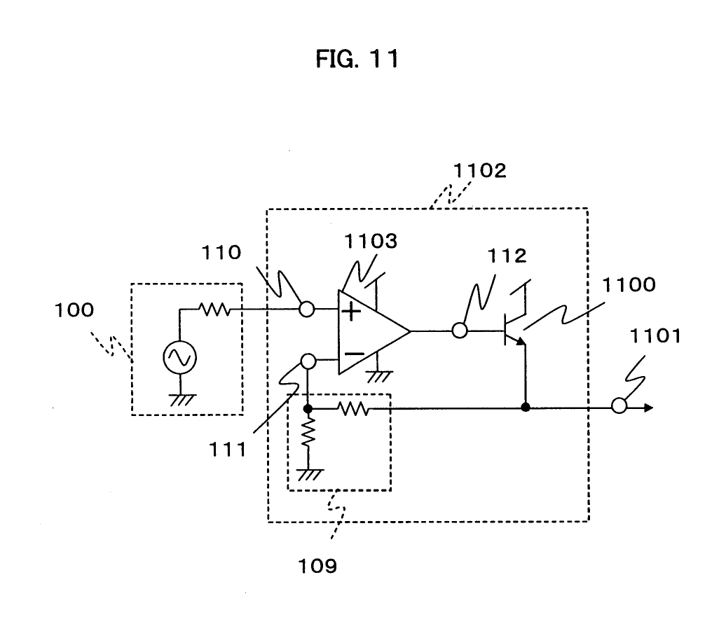

FIG. 11 shows a circuit diagram of an amplitude modulator 1102 according to the sixth embodiment of the present invention. The amplitude modulator 1102 according to the present embodiment is composed of an operational amplifier 1103, a DC-DC converter 1100 composed of an emitter follower, and the feedback circuit 109. Reference numeral 1101 represents an amplitude modulation output terminal. Note herein that the same reference numeral is given to an element having the same function as that of the first through the fifth embodiments, and description thereof will be omitted.

The aforementioned operational amplifier 1103 has already been described in the first through the fifth embodiments, and for the purpose of avoiding duplication, description of the operation will be omitted.

An amplitude modulation signal outputted from the signal generator 100 is amplified in the same polarity by the operational amplifier 1103, and is inputted into abase terminal of an emitter follower composing a DC-DC converter 1100. Since a voltage gain of the emitter follower composing the DC-DC converter 1100 is one, an amplitude modulation signal that is amplified by the operational amplifier 1103 in the same polarity is outputted as an output of the DC-DC converter 1100. Meanwhile, a current gain is determined by a current amplification factor Hfe of the emitter follower composing the DC-DC converter 1100, and when the current amplification factor Hfe is about, for example 100, the output current of 1 A is obtained by the base current of 10 mA.

The outputted amplitude modulation signal is further fed back to the negative feedback terminal 111 of the operational amplifier 1103 by the feedback circuit 109, and the feedback is performed so that a difference between the amplitude modulation signal inputted into the positive feedback terminal 110 and the amplitude modulation signal fed back to the negative feedback terminal 111 may be zero. As a result of this, the voltage gain according to a feedback ratio of the feedback circuit 109 as an amplitude modulator 1102, and an output voltage capability resulting from a multiplication between an output voltage capability of the operational amplifier 1103 and the current gain of the emitter follower composing the DC-DC converter 1100 can be achieved.

According to the present embodiment, since the operational amplifier 1103 is composed of the highly efficient operational amplifier described in the first through fifth embodiments, a highly efficient amplitude modulator can be is realized.

### Seventh Embodiment

Hereafter, a seventh embodiment of the present invention will be described with reference to the drawings.

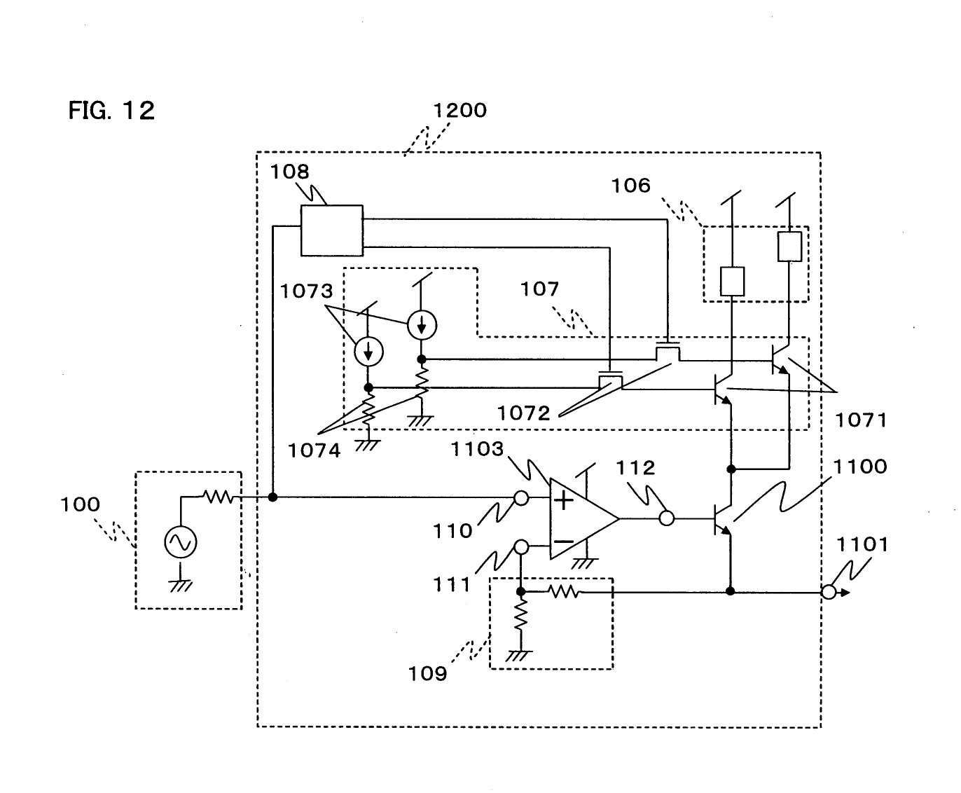

FIG. 12 shows a circuit diagram of an amplitude modulator according to the seventh embodiment of the present invention. An amplitude modulator 1200 according to the present embodiment is composed of the operational amplifier 1103, the DC-DC converter 1100 composed of the emitter follower, the feedback circuit 109, the plurality of power supply circuits 106, the switch circuit 107, and the drive circuit 108. Reference numeral 1101 represents an amplitude modulation output terminal.

Note herein that the same reference numeral is given to an element having the same function as that of the first through the fifth embodiments, and description thereof will be omitted.

According to the present embodiment, a collector voltage of the emitter follower corresponding to the DC-DC converter 1100 is switched in the same technique as the power supply switching technique described in the first embodiment.

A reference voltage of the drive circuit 108 is determined as follows. A reference voltage when the delay is not taken into consideration will be selected as follows. Assuming that a voltage gain (closed loop gain) of the amplitude modulator 1200 is A, an output voltage of the plurality of power supply circuits 106 in selecting the low voltage is VL, a drop voltage of the NPN transistor 1071 of the switch circuit 107 during the operation is Vd, and a collector-emitter saturation voltage of the transistor of the emitter follower corresponding to the DC-DC converter 1100 is Vsat, the reference voltage Vref will be expressed by formula (10) as follows.
Vref=(VL−Vd−Vsat)/A (10)

Next, a reference voltage when the delay is taken into consideration will be determined as follows. A propagation delay of the drive circuit 108, a propagation delay from the drive circuit 108 to the switch circuit 107, a propagation delay of the switch circuit 107 are assumed to be t1, t2, and t3, respectively. Supposing that a slew rate S1 of the input signal near the reference voltage Vref has been known beforehand, a voltage difference ΔV due to the delay will be expressed by formula (11).
ΔV=S1(t1+t2+t3) (11)

Hence, the reference voltage in consideration of the delay will be provided by Vref−ΔV.

The amplitude modulator 1200 of the present embodiment operates such that, by comparing a voltage of the amplitude modulation signal inputted into the amplitude modulator with the reference voltage, the voltage applied between the emitter and the collector of the emitter follower corresponding to the DC-DC converter 1100 my be decreased. Note herein that, since the portion concerning the amplitude modulation is the same as that of the sixth embodiment, description thereof will be omitted.

As described above, according to the present embodiment, the highly efficient operational amplifier described in the first through fifth embodiments is employed, and the supply voltage is further selected so that the voltage between the emitter and the collector of the DC-DC converter 1100 may be decreased, so that power consumption in the DC-DC converter can be reduced, allowing more highly efficient amplitude modulator to be achieved as compare with the sixth embodiment.

### Eighth Embodiment

Hereafter, an eighth embodiment of the present invention will be described with reference to the drawings.

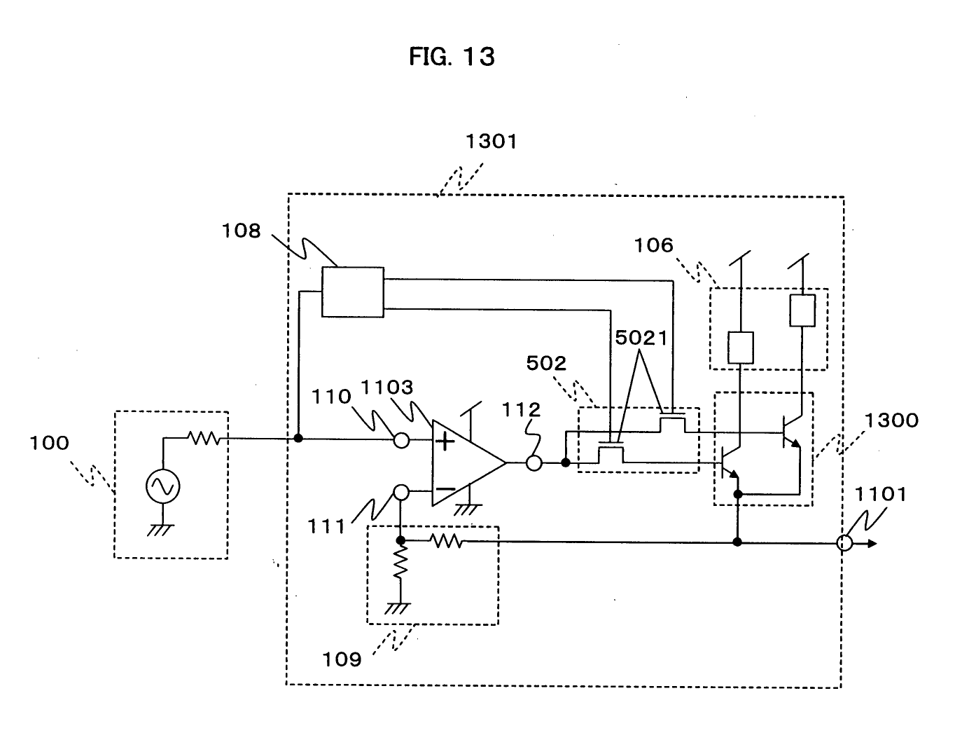

FIG. 13 shows a circuit diagram of an amplitude modulator according to the eighth embodiment of the present invention. An amplitude modulator 1301 according to the present embodiment is composed of the operational amplifier 1103, a plurality of DC-DC converters 1300 composed of an emitter follower group, the feedback circuit 109, the plurality of power supply circuits 106, the switch circuit 502, and the drive circuit 108. Reference numeral 1101 represents an amplitude modulation output terminal.

Note herein that the same reference numeral is given to an element having the same function as that of the first through the fifth embodiments, and description thereof will be omitted.

According to the present embodiment, any one of the signal paths between the output from the operational amplifier 1103 and the emitter follower group corresponding to the plurality of DC-DC converters 1300 is selected in the same technique as the power supply switching technique described in the second embodiment.

A reference voltage of the drive circuit 108 is determined as follows. Assuming that a voltage gain of the amplitude modulator 1301 is A, an output voltage of the plurality of power supply circuits 106 in selecting the low voltage is VL, and a collector-emitter saturation voltage of the transistor of the emitter follower group corresponding to the plurality of DC-DC converters 1300 is Vsat, the reference voltage Vref will be expressed by formula (12) as follows.
Vref=(VL−Vsat)/A (12)

Next, a reference voltage when the delay is taken into consideration will be determined as follows. A propagation delay of the drive circuit 108, a propagation delay from the drive circuit 108 to the switch circuit 502, a propagation delay of the switch circuit 502 are assumed to be t1, t2, and t3, respectively. Supposing that a slew rate S1 of the signal near the reference voltage Vref has been known beforehand, a voltage difference ΔV due to the delay will be expressed by formula (13) as follows.
ΔV=S1(t1+t2+t3) (13)

Hence, the reference voltage in consideration of the delay will be provided by Vref−ΔV.

The amplitude modulator 1301 of the present embodiment operates such that, by comparing a voltage of the amplitude modulation signal inputted into the amplitude modulator 1301 with the reference voltage, and selecting any one of the plurality of DC-DC converters 1300 connected with the plurality of power supply circuits 105, the voltage applied between the emitter and the collector of the emitter follower corresponding to the DC-DC converter 1300 my be decreased.

Note herein that, since the description of the portion concerning the amplitude modulation is the same as that of the sixth embodiment, it will be omitted.

As described above, according to the present embodiment, the highly efficient operational amplifier described in the first through fifth embodiments is employed, and any one of the plurality of the DC-DC converters 1300 which form pairs with the plurality of power supply circuits 106 is selected, so that a voltage between an emitter and a collector voltage of the DC-DC converter 1300 can be decreased, thus achieving a reduction in power consumption. Further, as compared with the seventh embodiment, since the switch circuit 107 is not disposed between the plurality of power supply circuits 106 and the plurality of DC-DC converters 1300, a reduction in power consumption due to the voltage drop of the switch circuit 107 can be achieved, allowing more highly efficient amplitude modulator to be achieved as compare with the seventh embodiment.

### Ninth Embodiment

Hereafter, a ninth embodiment of the present invention will be described with reference to the drawings.

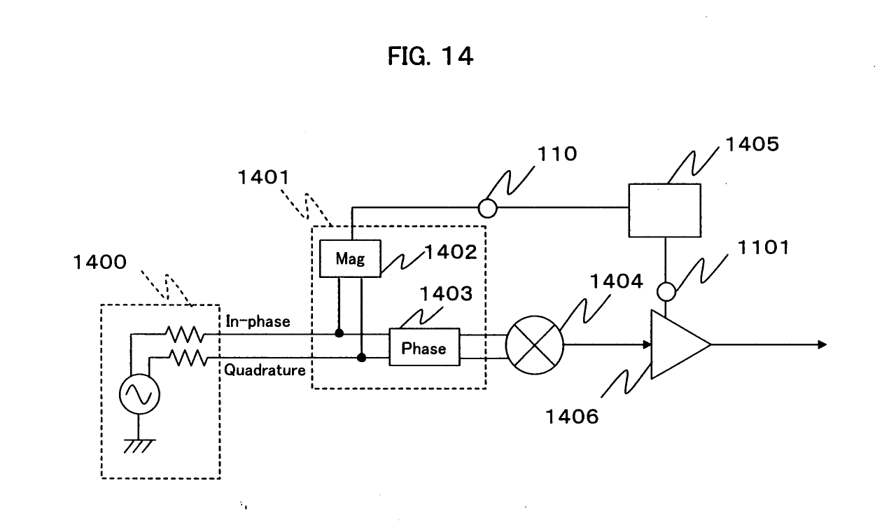

FIG. 14 shows a circuit diagram of a transmitter according to the ninth embodiment of the present invention. The transmitter according to the present embodiment is composed of a modulation signal generating circuit 1400, an amplitude/phase detection circuit 1401 composed of an amplitude detection circuit 1402 and a phase detection circuit 1403, a quadrature modulator 1404, an amplitude modulator 1405, and an RF power amplifier 1406.

The amplitude modulator 1405 is the amplitude modulator described in the sixth through eighth embodiments, and can be operated highly efficiently.

Hereinafter, the operation will be explained.

The transmitter in the present embodiment is a transmitter for performing an EER technique, and a modulation signal I+jQ involving the amplitude that is generated by the modulation signal generating circuit is separated into an amplitude component and a phase component by following formulas.
Amplitude component=√(I²+Q²)
Phase component=tan⁻¹(Q/I)

Herein, the amplitude detection circuit 1402 and the phase detection circuit 1403 of the amplitude/phase detection circuit 1401 perform operations of the above formulas. The signals separated into the amplitude component and the phase component are sent to the amplitude modulator 1405 and the quadrature modulator 1404, respectively.

In the amplitude modulator 1405, the amplitude component is multiplied by a gain that the amplitude modulator has, and then inputted into the power supply terminal of the RF power amplifier 1406. Meanwhile, the phase component is frequency-converted into a carrier frequency by the quadrature modulator 1404, and inputted into an RF input terminal of the RF power amplifier 1406.

The RF power amplifier 1406, which is a saturated type amplifier, receives the RF signal (signal obtained by frequency-converting the phase component) supplied from the quadrature modulator 1404 at an RF input terminal, receives the amplitude component that is DC-converted by the amplitude modulator at a power supply terminal, and eventually outputs the modulated wave whose phase and amplitude are both modulated, namely whose amplitude and phase are multiplied.

In the EER technique, since the RF power amplifier can be driven in the saturated mode, a highly efficient transmitter can be realized.

As described above, according to the EER technique of the present embodiment, in addition to the highly efficient operation of the RF power amplifier using the EER technique, an improvement in efficiency as the EER technique can be achieved by using the highly efficient amplitude modulator.

### Tenth Embodiment

Hereafter, a tenth embodiment of the present invention will be described with reference to the drawings.

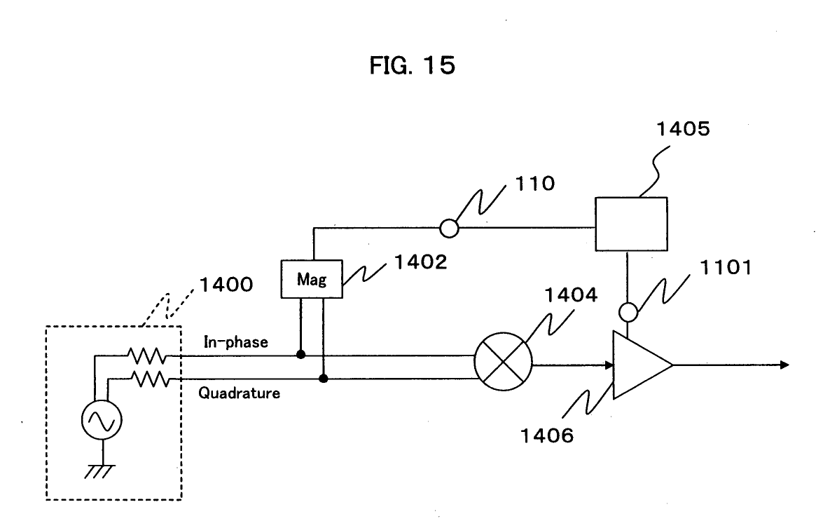

FIG. 15 shows a circuit diagram of a transmitter according to the tenth embodiment of the present invention. The transmitter according to the present embodiment is composed of the modulation signal generating circuit 1400, the amplitude detection circuit 1402, the quadrature modulator 1404, the amplitude modulator 1405, and the RF power amplifier 1406. The same reference numeral is given to an element having the same function as that of the ninth embodiment, and description thereof will be omitted.

The tenth embodiment is different from the ninth embodiment in that the phase component of the modulation signal is not inputted into the quadrature modulator 1404, but the modulation signal itself is inputted into the quadrature modulator 1404 as it is.

Additional advantages expected from the tenth embodiment is to be able to avoid deterioration of modulation accuracy (Error Vector Magnitude: EVM), which could not be avoided in the EER method in which the signal has been separated into the amplitude component and the phase component, because not the phase component but the modulation signal is provided to the RF power amplifier 1406 via the quadrature modulator 1404 as it is. That is, while, when the phase component is used, the phase component is filtered within a range that a bandwidth of a digital-to-analog converter allows, and to the extent of not affecting the EVM, a partial amplitude drop of the phase component produced by the filtering has caused remarkable deterioration in EVM, when the phase component has been synthesized with the amplitude component at the output of the RF power amplifier. In addition, since a necessary bandwidth of the modulation signal is smaller than that of the phase component separated from the modulation signal by about ⅙, a bandwidth of an anti-aliasing filter which suppresses a spurious component produced by a digital-to-analog converter and a digital-to-analog conversion can be narrowed. Hence, it is advantageous for reduction in power consumption of the digital-to-analog converter, and a reduction in cost of a circuit following it.

Additionally, according to the conventional EER method, since the output level for sufficiently saturating the RF power amplifier has been injected even when a peak power has been inputted, when an isolation characteristic when the RF power amplifier has been in OFF-state (the amplitude component is 0) has been unfavorable, a multiplication with the amplitude component has not been performed correctly, so that an original modulated wave has not been able to be restored (deterioration of EVM performance has been caused). According to this configuration, when the RF power amplifier is in OFF-state (amplitude component is 0), the electric power inputted into the RF power amplifier is also 0, so that a correct modulated wave can be restored without depending on the isolation characteristic.

### INDUSTRIAL AVAILABILITY

According to the present invention, the operational amplifier and the amplitude modulator can be highly efficiently operated, and using these operational amplifier and amplitude modulator in the EER technique which can operate the RF power amplifier as the saturated type amplifier can provide an advantage for allowing a wide band and highly efficient operation, so that the present invention is useful as a transmitter or the like of a communication system using a multicarrier signal, such as an OFDM (Orthogonal Frequency Division Multiplex) system.

What is claimed is:

1. An operational amplifier comprising:
a differential amplifier for receiving a signal electric power;
a power amplification circuit for amplifying an output voltage of said differential amplifier; and
power control means for step-wisely switching at least either of a DC power supply voltage applied to said power amplification circuit and a direct current supplied to said power amplification circuit according to a voltage amplitude value of said signal electric power.

2. The operational amplifier according to claim 1, further comprising a phase compensation circuit which is located between the output terminal of said differential amplifier and an output terminal of said power amplification circuit and adjusts the amount of phase advance of the output voltage of said power amplification circuit, with respect to said signal electric power.

3. The operational amplifier according to claim 1, wherein said power control means includes
a plurality of power supply circuits which have step-wisely different voltage values and supply DC power to said power amplification circuit,
a switch circuit which is located between said plurality of power supply circuits and said power amplification circuit, and selects any one of said plurality of power supply circuits, and
a control circuit which receives voltage amplitude information of said signal electric power and controls said switch circuit based on the voltage amplitude information of said signal electric power.

4. The operational amplifier according to claim 1,
wherein a plurality of said power amplification circuits are provided, and output terminals of the plurality of power amplification circuits are commonly connected together, and
wherein said power control means includes
a plurality of power supply circuits which form pairs with said plurality of power amplification circuits, and have step-wisely different voltage values to supply DC power to said plurality of power amplification circuits,
a switch circuit which is located between the output terminal of said differential amplifier and an input terminal of said plurality of power amplification circuits, and selects a connection between said differential amplifier and said plurality of power amplification circuits, and
a control circuit which receives voltage amplitude information of said signal electric power and controls said switch circuit based on the voltage amplitude information of said signal electric power.

5. The operational amplifier according to claim 1, wherein said power control means includes
a plurality of current source circuits which have step-wisely different current values and supply direct currents to said power amplification circuit,
a switch circuit for selecting any one of said plurality of current source circuits, and
a control circuit which receives voltage amplitude information of said signal electric power and controls said switch circuit based on the voltage amplitude information of said signal electric power.

6. The operational amplifier according to claim 1, wherein said power control means includes
a plurality of power supply circuits which have step-wisely different voltage values and supply DC power to said power amplification circuit,
a first switch circuit which is located between said plurality of power supply circuits and said power amplification circuit, and selects any one of said plurality of power supply circuits,
a plurality of current source circuits which have step-wisely different current values and supply direct currents to said power amplification circuit,
a second switch circuit for selecting any one of said plurality of current source circuits, and
a control circuit which receives voltage amplitude information of said signal electric power and controls said first and second switch circuits based on the voltage amplitude information of said signal electric power.

7. The operational amplifier according to claim 1,
wherein a plurality of said power amplification circuits are provided, and output terminals of the plurality of power amplification circuits are commonly connected together, and
wherein said power control means includes
a plurality of power supply circuits which form pairs with said plurality of power amplification circuits, and have step-wisely different voltage values to supply DC power to said plurality of power amplification circuits,
a first switch circuit which is located between the output terminal of said differential amplifier and the input terminal of said plurality of power amplification circuits, and selects a connection between said differential amplifier and said plurality of power amplification circuits,
a plurality of current source circuits which have step-wisely different current values and supply direct currents to said power amplification circuit,
a second switch circuit for selecting any one of said plurality of current source circuits, and
a control circuit which receives voltage amplitude information of said signal electric power and controls said first and second switch circuits based on the voltage amplitude information of said signal electric power.

8. The operational amplifier according to claim 3,
wherein said control circuit is composed of a plurality of comparator circuits, and
wherein assuming that a propagation delay of said plurality of comparator circuits is t1, a propagation delay from said comparator circuit to said switch circuit is t2, a propagation delay of said switch circuit is t3, a time when a voltage obtained by multiplying a reference voltage of said plurality of comparator circuits by a gain of said power amplification circuit is equal to said voltage amplitude value of the signal electric power is tx, and a voltage amplitude value of said signal electric power at time tx−(t1+t2+t3) is Vy, the reference voltage of said plurality of comparator circuits is selected so that the output voltage of said plurality of power supply circuits may be larger than Vy.

9. The operational amplifier according to claim 4,
wherein said control circuit is composed of a plurality of comparator circuits, and
wherein assuming that a propagation delay of said plurality of comparator circuits is t1, a propagation delay from said comparator circuit to said switch circuit is t2, a propagation delay of said switch circuit is t3, a time when a voltage obtained by multiplying a reference voltage of said plurality of comparator circuits by a gain of said power amplification circuit is equal to said voltage amplitude value of the signal electric power is tx, and a voltage amplitude value of said signal electric power at time tx−(t1+t2+t3) is Vy, the reference voltage of said plurality of comparator circuits is selected so that the output voltage of said plurality of power supply circuits may be larger than Vy.

10. The operational amplifier according to claim 5,
wherein said control circuit is composed of a plurality of comparator circuits, and
wherein assuming that a propagation delay of said plurality of comparator circuits is t1, a propagation delay from said comparator circuit to said switch circuit is t2, a propagation delay of said switch circuit is t3, a time when a voltage obtained by multiplying a reference voltage of said plurality of comparator circuits by a gain of said power amplification circuit is equal to said voltage amplitude value of the signal electric power is tx, and a voltage amplitude value of said signal electric power at time tx−(t1+t2+t3) is Vy, the reference voltage of said plurality of comparator circuits is selected so that the output voltage of said plurality of power supply circuits may be larger than Vy.

11. An amplitude modulator comprising:
the operational amplifier according to claim 1;
a DC-DC converter for DC converting an output of said operational amplifier; and
a feedback circuit for feeding back an output of said DC-DC converter to a feedback terminal of said operational amplifier.

12. The amplitude modulator according to claim 11, further comprising:
a plurality of power supply circuits for converter for supplying DC power to said DC-DC converter;
a switch circuit for converter which is located between said plurality of power supply circuits for converter and said DC-DC converter, and selects any one of said plurality of power supply circuits for converter; and
a control circuit for converter which receives voltage amplitude information of said signal electric power and controls said switch circuit for converter based on the voltage amplitude information of said signal electric power.

13. The amplitude modulator according to claim 11,
wherein a plurality of said DC-DC converters are provided, and output terminals of said plurality of DC-DC converters are commonly connected together, and
wherein the amplitude modulator further comprises
a plurality of power supply circuits for converter which form pairs with said plurality of DC-DC converters and supply DC power to said plurality of DC-DC converters;
a switch circuit for converter which is located between said operational amplifier and said plurality of DC-DC converters and selects a connection between said operational amplifier and said plurality of DC-DC converters; and
a control circuit for converter which receives voltage amplitude information of said signal electric power and controls said switch circuit for converter based on the voltage amplitude information of said signal electric power.

14. The amplitude modulator according to claim 12,
wherein said control circuit for converter is composed of a plurality of comparator circuits, and
wherein assuming that a propagation delay of said plurality of comparator circuits is t1, a propagation delay from said comparator circuit to said switch circuit for converter is t2, a propagation delay of said switch circuit for converter is t3, a time when a voltage obtained by multiplying a reference voltage of said plurality of comparator circuits by a gain of said power amplification circuit is equal to said voltage amplitude value of the signal electric power is tx, and a voltage amplitude value of said signal electric power at time tx−(t1+t2+t3) is Vy, the reference voltage of said plurality of comparator circuits is selected so that the output voltage of said plurality of power supply circuits for converter may be larger than Vy.

15. The amplitude modulator according to claim 13,
wherein said control circuit for converter is composed of a plurality of comparator circuits, and
wherein assuming that a propagation delay of said plurality of comparator circuits is t1, a propagation delay from said comparator circuit to said switch circuit for converter is t2, a propagation delay of said switch circuit for converter is t3, a time when a voltage obtained by multiplying a reference voltage of said plurality of comparator circuits by a gain of said power amplification circuit is equal to said voltage amplitude value of the signal electric power is tx, and a voltage amplitude value of said signal electric power at time tx−(t1+t2+t3) is Vy, the reference voltage of said plurality of comparator circuits is selected so that the output voltage of said plurality of power supply circuits for converter may be larger than Vy.

16. A transmitter comprising:
a modulation signal generator;
a phase/amplitude detector which is composed of an amplitude detector for detecting an amplitude component of a modulation signal generated by said modulation signal generator, and a phase detector for detecting a phase component of the modulation signal generated by said modulation signal generator;
an amplitude modulator according to claim 11 for receiving the amplitude component detected by said phase/amplitude detector;
a frequency converter for converting the phase component detected by said phase/amplitude detector into a carrier frequency;
an RF power amplifier for receiving an output of said amplitude modulator and an output of said frequency converter to thereby generate a modulated wave.

17. A transmitter comprising:
a modulation signal generator;
an amplitude detector for detecting an amplitude component of a modulation signal which is generated by said modulation signal generator;
the amplitude modulator according to claim 11 for receiving the amplitude component detected by said amplitude detector;
a frequency converter for converting the modulation signal generated by said modulation signal generator, into a carrier frequency; and
an RF power amplifier for receiving an output of said amplitude modulator and an output of said frequency converter to thereby generate a modulated wave.
